(19) United States
(12) Patent Application Publication
(10) Pub. No.: US 2020/0185209 A1
(43) Pub. Date: Jun. 11, 2020

(54) ELECTRODE ARRAY DEVICES AND METHODS

(71) Applicant: Yang Cui, Sunnyvale, CA (US)

(72) Inventor: Yang Cui, Sunnyvale, CA (US)

(21) Appl. No.: 16/544,800

(22) Filed: Aug. 19, 2019

Related U.S. Application Data
(60) Provisional application No. 62/777,198, filed on Dec. 9, 2018.

(51) Int. Cl. H01J 49/06; H01J 49/10; G01N 30/72; H01J 49/16

(52) U.S. Cl. CPC H01J 49/065; H01J 49/165; G01N 30/7266; H01J 49/105

(57) ABSTRACT

A plurality of electrodes may be arrayed to provide a lateral passage for analyte particles introduced off-axis, communicating with a central passage aligned with an outlet.

### CROSS REFERENCE TO RELATED APPLICATION

This application claims priority from U.S. Provisional Patent Application No. 62/777,198, entitled Apparatus for Manipulating Ions and Other Charged Particles Using Stacked-Multipole Electrode Ion Collector, filed Dec. 9, 2018, which is incorporated herein by reference in its entirety.

### BACKGROUND

An important technique of analytical chemistry is LC/MS (liquid chromatography/mass spectrometry), which entails fractionation of samples by liquid chromatography, followed by mass spectrometric analysis of the resulting fractions, optionally in a seamless process wherein a chromatographic instrument is coupled directly to a mass spectrometric instrument. In an often-encountered use case, this requires transforming the chromatographic outflow, typically an electrically neutral liquid phase analyte at atmospheric pressure, into an electrically charged gas phase analyte in high vacuum as may be required for mass spectrometry.

Currently, ionization and vaporization are commonly accomplished by electrospray ionization, and the resulting analyte stream, typically containing ionized analyte particles in gas phase as well as non-ionized species and liquid droplets, is introduced into the first vacuum stage of a mass spectrometric instrument via an “atmospheric pressure inlet”, a small orifice or capillary whose fluid conductance is too small to impair the maintenance of vacuum inside the chamber. Pressure can be further reduced stepwise using additional vacuum stages or chambers, communicating with the preceding stage via an orifice or passage of small diameter, allowing analyte particles to pass but not allowing sufficient gas flow to unduly affect the pressure differential.

Ions may be focused into a narrow beam to efficiently pass through these small apertures. Ions that deviate from the path through the aperture are not transmitted, resulting in decrease of useful analytical signal. With devices using atmospheric pressure electrospray ionization, a difficult step in the ion transfer process is the injection into the first vacuum chamber. As the atmospheric pressure electrospray output enters the vacuum, it may undergo free jet expansion, spreading off axis at sonic or supersonic speeds. The ions and charged microdroplets of analyte are caught in the expansion and only a very small fraction remains focused along the axis. Without focusing ion optics, a majority of the analyte would be lost in the first vacuum compartment. This represented a vexing challenge during early development of electrospray ionization and remains a significant cause of analyte ion loss in current mass spectrometers. Various ion focusing solutions have been developed, such as stacked ring ion guide devices, circular ring ion funnel devices, and conjoined stacked ring ion guide devices. These are effective to varying degrees in reducing ion loss, but current devices suffer from several drawbacks: (1) the ion focus achieved remains suboptimal; (2) some neutral particles and droplets are propelled toward the outlet orifice by the free jet expansion at the inlet; (3) inadequate separation of analyte ions from neutral particles and droplets leads to contamination of the output analyte stream; and (4) over time, contamination due to deposition of neutrals and droplets on the electrodes of the focusing optics results in alteration of the electromagnetic field impairment of field stability.

### SUMMARY

In general, disclosed herein are various embodiments of novel methods, systems, devices, apparatus, compositions, articles of manufacture, and improvements thereof useful for focusing and/or manipulating electrically charged particles such as ions. In some embodiments, there may be provided an ion focusing device wherein ions enter the device off-axis from an outlet, and are guided onto a trajectory eventually converging on an outlet without colliding with electrodes, while neutrals and/or contaminants continue on an alternate path displaced from an outlet axis, thus maintaining high ion transmission at relatively high pressure and avoiding contamination of electrodes by neutrals and other contaminants.

Thus in some embodiments there may be provided an electrode array of novel design, which may include stacked multipole electrode layers having multiple discrete electrodes that may be spaced apart laterally to provide one or more paths whereby charged particles in an analyte stream emitting from one or more off-axis analyte sources may be diverted into alignment with an outlet aperture, as well as one or more paths whereby neutral particles and other undesired species in the analyte stream may continue on a trajectory displaced away from the outlet stream. In some embodiments, an electrode array may be operated to focus and/or manipulate ions and/or other charged species by applying radio frequency (RF) and/or direct current (DC) potentials to electrodes to produce an electromagnetic field. In some embodiments, an electrode array may be enclosed in an evacuable enclosure having one or more inlets, which may be off-axis inlets, for introducing analyte streams, and an outlet through which an output stream may be directed.

In an aspect of some embodiments, there is provided an electrode array which may have an upstream end and a downstream end, and may include a plurality of electrode layers, each electrode layer including a plurality of electrodes disposed around a central aperture and spaced apart one from the other to provide an open inter-electrode space comprising the central aperture and at least one lateral gap contiguous with the central aperture and extending outward therefrom between adjacent electrodes; wherein the electrode layers may be disposed in a stacked arrangement whereby the central apertures of the electrode layers are aligned to provide a central passage through the central apertures of a plurality of adjacent electrode layers and extending to the downstream end of the electrode array, and lateral gaps of the electrode layers may be aligned to provide at least one lateral passage extending through the lateral gaps of a plurality of adjacent electrode layers and communicating with the central passage, and wherein the central aperture cross-section of successive electrode layers is decreasing in the downstream direction over at least a portion of the electrode array.

In another aspect of some embodiments, there may be provided a direct current (DC) power supply controllable to apply DC potentials to electrodes of the electrode array, and/or a radio frequency (RF) power supply controllable to apply RF potentials to a plurality of electrodes in a plurality of electrode layers of the electrode array.

In another aspect of some embodiments, there may be provided an evacuable enclosure and an electrode array may be disposed therein, and there may be provided an outlet from the enclosure having an outlet axis aligned within the central passage of the electrode array and one or more analyte inlets which may be displaced laterally from the outlet axis and aligned to emit analyte into a lateral passage of the electrode array.

In another aspect of some embodiments, there may be provided an end plate or outlet layer including a neutral particle collision zone and an aperture, wherein the electrode array and end plate are aligned and oriented to provide an unobstructed line-of-sight path extending from an inlet through a lateral passage to the neutral particle collision zone, and the aperture of the end plate is aligned with the central passage of the electrode array. In an aspect of some embodiments, an electrode array and end plate or outlet later may be disposed in an evacuable enclosure wherein the end plate or outlet layer forms a part of the evacuable enclosure, such as, for example, wherein the evacuable enclosure includes a gas-impermeable shell having a passage therein aligned to receive the outlet layer of the electrode array assembly, and a seal for establishing a gas-impermeable barrier between the end plate or outlet layer and the passage of the gas-impermeable shell.

In another aspect of some embodiments, there may be provided a method of using an electrode array including, in an evacuated chamber, injecting ionized particles into a lateral passage of the electrode array, applying DC and/or RF potentials to a plurality of the electrodes of the array to produce an electromagnetic field, and controlling the electromagnetic field to divert ionized particles into the central passage of the electrode array.

In some embodiments, an object of the disclosure hereof is, in ion guide and/or other ion optics applications, minimize contamination of electrodes and consequent distortion of electromagnetic fields.

In some embodiments, an object of the disclosure hereof is, in ion guide and/or other ion optics applications, optimize focusing and minimize loss of analyte ions.

In some embodiments, an object of the disclosure hereof is, in ion guide and/or other ion optics applications, provide a trajectory for neutral particles and/or contaminants displaced away from the trajectory of analyte ions.

In some embodiments, an object of the disclosure hereof is, in ion guide and/or other ion optics applications, provide for practicable ion focusing from one, two, or more atmospheric pressure inlets, one or more of which may be offset or displaced from a line-of-sight trajectory from the inlet position to an outlet.

In some embodiments, an object of the disclosure hereof is, in ion guide and/or other ion optics applications, provide electrode configurations allowing for fine-grained control of electromagnetic field characteristics.

It will be apparent to persons of skill in the art that various of the foregoing aspects and/or objects, and various other aspects and/or objects disclosed herein, can be incorporated and/or achieved separately or combined in a single device, method, system, composition, article of manufacture, and/or improvement thereof, thus obtaining the benefit of more than one aspect and/or object, and that an embodiment may encompass none, one, or more than one but less than all of the aspects, objects, or features enumerated in the foregoing summary or otherwise disclosed herein. The disclosure hereof extends to all such combinations. In addition to the illustrative aspects, embodiments, objects, and features described above, further aspects, embodiments, objects, and features will become apparent by reference to the drawing figures and detailed description. Also disclosed herein are various embodiments of related methods, devices, apparatus, compositions, systems, articles of manufacture, and/or improvements thereof. The foregoing summary is intended to provide a brief introduction to the subject matter of this disclosure and does not in any way limit or circumscribe the scope of the invention(s) disclosed herein, which scope is defined by the claims currently appended or as they may be amended, and as interpreted by a skilled artisan in the light of the entire disclosure.

### BRIEF DESCRIPTION OF THE FIGURES

FIG. 1 depicts a cutaway perspective view of an exemplary embodiment of an ion guide device including an electrode array consistent with the disclosure hereof.

FIG. 2 depicts schematically a perspective exploded view illustrating various features of an embodiment of an electrode array consistent with the disclosure hereof.

FIGS. 3A and 3B depict plan and side views, respectively, of an embodiment of an electrode layer consistent with the disclosure hereof

FIG. 3C depicts another embodiment of an electrode layer consistent with the disclosure hereof.

FIG. 4A illustrates an embodiment of an 8-electrode electrode layer consistent with the disclosure hereof

FIG. 4B shows an embodiment of an electrode layer including triangular electrodes, consistent with the disclosure hereof.

FIG. 4C shows an embodiment of an electrode layer including polygonal electrodes, consistent with the disclosure hereof.

FIG. 5A depicts an exploded view of an embodiment, consistent with the disclosure hereof, of several electrode layers illustrating a central passage.

FIG. 5B depicts an exploded view of an embodiment, consistent with the disclosure hereof, of several electrode layers illustrating a lateral passage.

FIG. 6 depicts an end view of an embodiment of an electrode array consistent with the disclosure hereof.

FIG. 7 depicts a perspective view of another embodiment of an electrode array consistent with the disclosure hereof.

FIG. 8 depicts schematically, in longitudinal cross-section, another embodiment of an electrode array consistent with the disclosure hereof.

FIG. 9 depicts a perspective cutaway view of another embodiment of an electrode array consistent with the disclosure hereof.

FIG. 10 depicts schematically, in longitudinal cross-section, another embodiment of an electrode array consistent with the disclosure hereof.

FIG. 11 depicts schematically, in longitudinal cross-section, another embodiment of an electrode array consistent with the disclosure hereof.

FIG. 12 depicts schematically in exploded view various features of another embodiment of an electrode array consistent with the disclosure hereof, including an end plate.

FIG. 13 depicts an end view of another embodiment of an electrode array consistent with the disclosure hereof, having electrode layers which could be fabricated from printed circuit board material.

FIG. 14 illustrates, in cutaway perspective view, an exemplary embodiment consistent with the disclosure hereof, of a mass analysis instrument incorporating an electrode array.

FIG. 15 depicts schematically an embodiment, consistent with the disclosure hereof, of an electrical circuit for applying electrical potentials to an electrode layer.

FIG. 16 depicts schematically, an embodiment, consistent with the disclosure hereof, of an electrical circuit for applying electrical potentials to one electrode of each of a plurality of electrode layers.

Figures are not to scale unless expressly so labeled, and relative positions and orientations of objects and components are illustrative and not limiting except where expressly so stated. Persons of skill in the art will recognize that many other arrangements, configurations, dimensions, orientations, and selections of components are possible and consistent with the disclosure hereof, and are in no way limited to the embodiments shown in the figures.

### DETAILED DESCRIPTION

Disclosed herein are embodiments of an electrode array together with methods, apparatus, compositions, systems, and articles of manufacture useful for manipulating ions and other electrically charged and/or uncharged particles and/or analyte streams that include such particles, and providing reduced contamination while maintaining high transmission and allowing operation over a larger pressure range. In some embodiments, the disclosed devices, systems, and methods may be found particularly useful for introducing ionized analytes into a mass spectrometric instrument while minimizing loss of analyte ions and contamination of electrodes and other components by neutral particles or other contaminants. In embodiments, there is provided an electrode array adapted to accommodate input of an analyte stream or spray at an “off-axis” inlet position displaced laterally from the axis of the desired outlet line of flight. The charged particles of interest may be deflected and/or guided by an electromagnetic field produced by the electrode array along a lateral ion path extending between the lobes of adjacent electrodes and merging into alignment with a central ion path aligned with an outlet passage, while neutrals and other contaminants pass harmlessly between electrodes on a displaced trajectory without affecting or contaminating the desired outlet stream. The outlet passage may in turn be coupled to one or more further vacuum zones and/or focusing stages and/or to a mass spectrometric or other instrument. Also disclosed are embodiments of methods, apparatus, compositions, systems, and articles of manufacture incorporating and/or making use of electrode arrays.

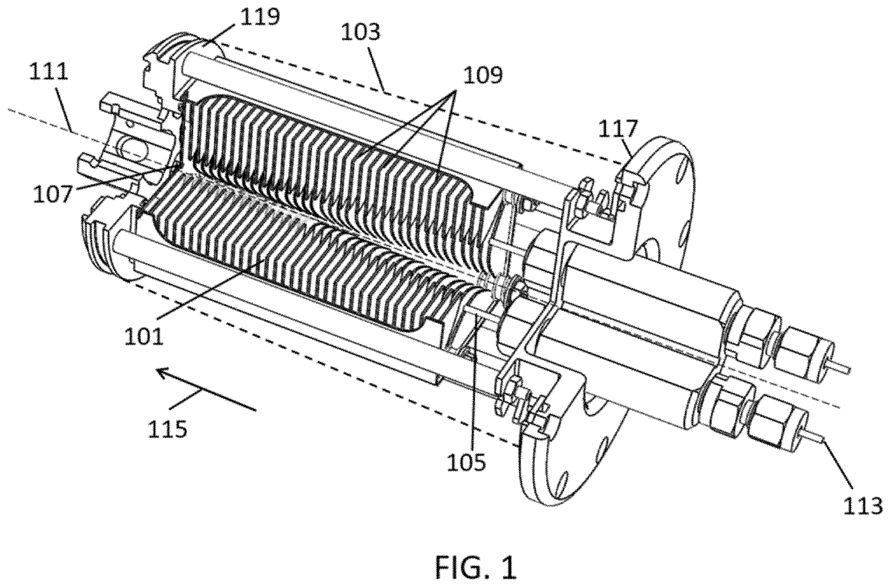

FIG. 1 depicts in cutaway view the broad outlines of an embodiment of an ion guide device incorporating an embodiment of an electrode array consistent with the disclosure hereof. An electrode array 101 may be enclosed in an evacuable enclosure 103, which could, for example, enclose the portion of the device between an upstream partition 117 and a downsteam partition 119. In embodiments, an electrode array may include a plurality of electrodes 109 disposed along a longitudinal axis and/or desired ion outlet path 111. One or more inlets 105 may be provided within the evacuable enclosure for introducing analytes, such as, for example, to inject an analyte stream including ions and/or other charged particles, which may be focused and/or manipulated by controlling the electrode array to produce an electromagnetic field operable to act on the analyte stream in a desired manner. A connection and/or interface 113 may be provided for coupling an external analyte source, such as, for example, the output of a chromatographic instrument, to an inlet so as to provide an analyte or ion stream. In embodiments, an ion stream may be routed in a generally downstream direction 115 along one or more ion paths from an inlet, extending through an electrode array and thence via an outlet 107 into another device, instrument, passage, vacuum stage, or other receptacle. For convenience and so as not to overly complicate the present disclosure, and except as otherwise explicitly stated or required by context, as used herein in connection with an electrode array device, “upstream” refers to the portion of a device where an inlet is positioned, or where, in normal operation according to the disclosure hereof, an analyte would be introduced; “downstream” refers to the portion of a device where an outlet is positioned, or where, in normal operation according to the disclosure hereof, a focused ion stream or other output stream would be emitted; and “output axis” refers to a straight line axis passing through and aligned with an output aperture. In the context of an exemplary embodiment of an electrode array device wherein electrodes are arranged in generally planar electrode layers disposed generally parallel one to another in a stack, “longitudinal” refers to the direction generally perpendicular to the planes of the electrode layers, and “lateral” refers to a direction generally perpendicular to the longitudinal direction. In relation to devices and or contexts that differ in one or more respects from the foregoing exemplary configurations, terms should be interpreted in a manner consistent with the foregoing.

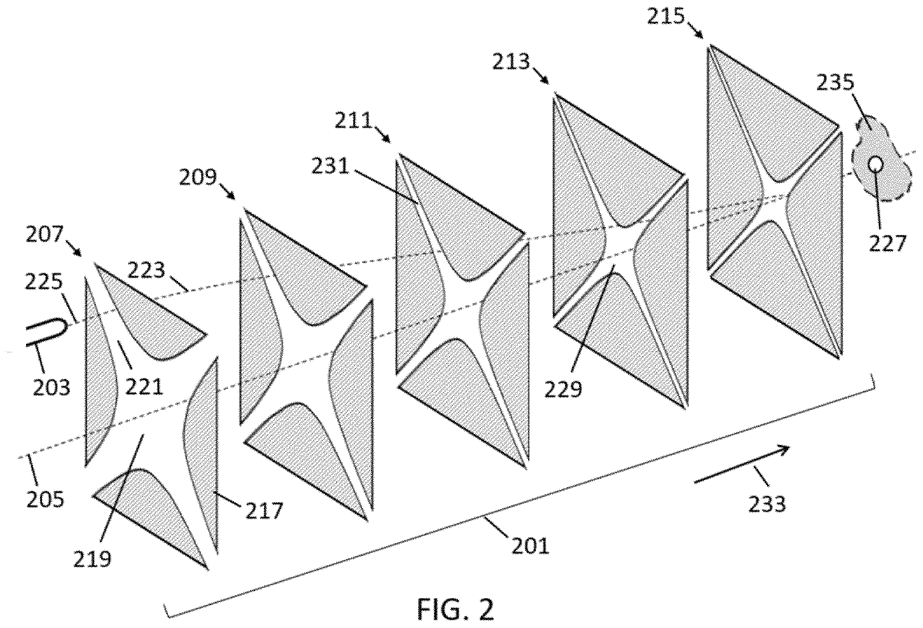

FIG. 2 depicts an exploded view illustrating the broad outlines of an exemplary embodiment of an electrode array 201 which could be employed in combination with an off-axis inlet or analyte injector 203 to focus an ion stream on an outlet orifice 227. In some embodiments, an electrode array may include a plurality of electrode layers 207, 209, 211, 213, 215 which may be disposed along a longitudinal axis 205 in a stacked arrangement. Each electrode layer may include a plurality of electrodes 217 disposed around a central aperture 219, with the electrodes spaced apart to provide a lateral gap 221 extending laterally (i.e. in a direction generally outward from the central aperture) between adjacent electrodes. The electrode layers may be disposed with their central apertures and/or lateral gaps aligned and oriented one with another so as to provide an unobstructed central ion passage passing longitudinally through the central apertures and at least one unobstructed lateral passage passing longitudinally between the electrodes of successive electrode layers. Thus, for example, ions emitted by an analyte injector 203 or other inlet positioned at a lateral displacement from the longitudinal axis 205 and oriented to emit an ion stream 225 toward a lateral gap 221 of an upstream electrode layer could be acted upon by an electromagnetic field produced by the electrode array in response to suitable applied potentials and thereby propelled along a trajectory 223 passing through the lateral gaps and/or central apertures of successive electrode layers and approaching and/or merging with a longitudinal axis 205 which may be aligned with an outlet orifice 227. In embodiments, an outlet orifice may be disposed in a partition 235 bounding an evacuable enclosure enclosing the electrode array. In embodiments, the dimensions and geometry of electrode layers and/or their component electrodes may be chosen whereby the central apertures, lateral gaps, or both diminish in size in the downstream direction 233 (i.e., the general direction of intended ion or analyte flow) over at least a portion of the longitudinal extent of an electrode array, so that, for example, an upstream electrode layer 207 may have a central aperture 219 that is larger in size than the central aperture 229 of an electrode layer 213 that is further downstream, and/or may have a lateral gap 221 that is larger in size than the lateral gap 231 of a more downstream electrode layer.

In some embodiments an electrode array may be incorporated into a device or instrument for focusing and/or manipulating an analyte stream. In most such embodiments the electrode array may be disposed within an evacuable enclosure into which an analyte stream could be injected via a suitable inlet. In embodiments, an analyte stream could include any stream or aggregation, continuous or discontinuous, composed of any one or more substances, in any phase and any concentration, capable of being emitted from an inlet. In some embodiments, an inlet may include any device or component operable to emit an analyte or analyte stream. In some embodiments, an inlet may be of a type known in the art as an atmospheric pressure inlet. In some embodiments, an inlet may include and/or be coupled to any ionization component operable to produce desired ionization of an analyte of interest, such as, for example, an electrospray ionization component, an atmospheric chemical ionization device, and/or an inductive coupled plasma ionization device. In some embodiments, an inlet may be coupled to a sample source, which may be external to an evacuable enclosure in which an electrode array may be disposed, and which could have any source pressure operable to supply an inlet with a desired sample stream. In some embodiments, for example, a sample source could provide a sample stream at a pressure of at least about 100 Torr and less than about 1000 Torr. In some embodiments, an inlet could include and/or be coupled to an atmospheric pressure ionizer operable to receive a liquid phase sample stream at a pressure of at least about 100 Torr and less than about 1000 Torr, and produce therefrom within an evacuable enclosure an analyte stream comprising ionized constituents of the sample stream. In some embodiments, an inlet may be positioned to emit analyte toward and/or into a lateral passage of an electrode array; this could be accomplished by positioning an inlet at a lateral displacement from a central passage and/or outlet axis of an electrode array, and/or in alignment with a lateral passage of an electrode array, and/or in an orientation whereby the stream emitted from an inlet is directed toward a lateral passage of an electrode array, and/or in any other manner operable to impart to analyte particles emitted by an inlet a trajectory passing into a lateral passage of an electrode array. Thus, for example, an inlet could be positioned on or near an outlet axis and/or a central passage but oriented at an angle so as to emit analyte into a lateral gap. In some embodiments, an inlet may be positioned and/or oriented in any manner whereby neutral particles are emitted by the inlet substantially on a trajectory or on trajectories displaced so as not to impinge on an outlet.

In some embodiments, an outlet or outlet aperture may include any aperture, opening, passage, or other feature operable to allow an analyte stream and/or ion stream to exit an evacuable enclosure in which an electrode array is enclosed; in some embodiments, an outlet may typically include an aperture of small dimension in a partition separating an evacuable chamber enclosing an electrode array from another chamber or device, which could include, for example, another evacuable chamber enclosing another electrode array according to the disclosure hereof; another vacuum stage; an ion guide, such as, for example, a quadrupole, hexapole, octupole, or other multipole ion guide or stacked ring ion guide; an instrument such as, for example, a mass analysis instrument and/or mass spectrometry instrument; or any other instrument, device, and/or component found useful for an application of interest, and which could, in turn, be coupled via one or more additional outlets to one or more additional chambers, instruments, devices, and/or components. In some embodiments, an analyte stream may typically be composed in whole or part of particles, which could include atoms, molecules, ions, aggregations of atoms, molecules, and/or ions, droplets, or any other small constituents of matter. In some embodiments, an analyte stream may be of any composition and/or characteristics compatible with and/or operable for analysis by any analytical instrument, such as, for example, a chromatography instrument and/or a mass spectrometric instrument and/or component thereof.

In some embodiments, an analyte stream may be generated by an electrospray ionization device and injected via an atmospheric pressure inlet into an evacuated enclosure within which it is to be focused and/or manipulated by an electrode array. In some embodiments, an electrode array may be disposed in an evacuable enclosure, which may include any structure and/or component and/or combination thereof operable to enclose an electrode array while maintaining a desired degree of vacuum within the enclosure. In some embodiments, an evacuable enclosure may include a shell of any dimensions and/or geometry and constructed of any one or more components. In some embodiments, it may be found useful to construct a shell and/or one or more components thereof from gas-impermeable materials. In some embodiments, an evacuable enclosure may be provided with one or more passages communicating from the interior to the exterior or from the exterior to the interior or both, to provide for inlets, outlets, vacuum pump connections, electrical connections, or any other purpose found useful. In embodiments, it may be found useful to provide for any such passages to be sealed against vacuum leakage, and/or designed whereby any vacuum leakage does not exceed the capacity of a vacuum pump to maintain a desired vacuum level.

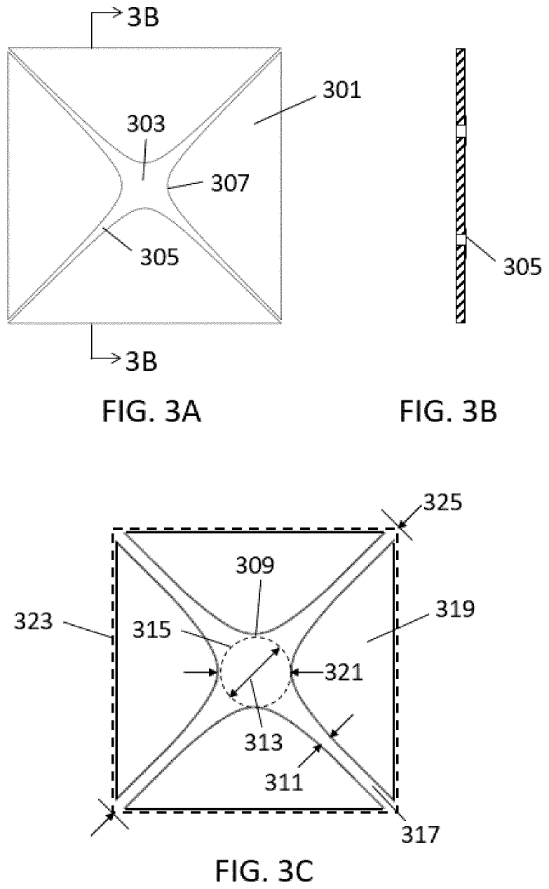

In some embodiments such as depicted in FIGS. 3A and 3B, an electrode layer may include a plurality of electrodes 301 disposed around a central aperture 303, with the electrodes spaced apart to provide a lateral gap 305 between adjacent electrodes and extending outward from the central aperture, providing a contiguous inter-electrode space bounded by the edges 307 of the electrodes and including the central aperture and any lateral gaps extending therefrom. In embodiments, an electrode layer may include any number of electrodes, each having any dimensions, geometry, orientation, composition, electrical characteristics, or other properties found useful for an application of interest. In some embodiments an electrode layer may be of substantially planar geometry and/or could be thin in cross-section relative to the lateral dimensions of the electrode layer, such as, for example, illustrated in FIGS. 3A and 3B. As shown in FIG. 3C, by varying the dimensions and geometry of electrodes 319 and the shape of the edge 309 bordering the inter-electrode space, an electrode layer may be constructed with an inter-electrode space having desired dimensions and geometry. In embodiments, as illustrated in FIG. 3C, the dimensions and/or geometry and/or effective cross-section of the inter-electrode space could be characterized in any manner and/or by any metric found useful, such as, for example, by the diameter 313 of the central aperture, the cross-sectional area of the central aperture, the width 311 of a lateral gap 317 (such as, for example, at a specified lateral distance from the central aperture), the cross-sectional area of a lateral gap, or the cross-sectional area of the inter-electrode space. In embodiments, the central aperture cross-section may be taken as the area of the largest circle 315 inscribable within the central aperture and the central aperture radius and diameter may be taken, respectively, as the radius and diameter of such a circle. In embodiments, the effective cross-section of the inter-electrode space and/or the size of the interelectrode space or portion thereof of a first electrode layer could be said to be larger than that of a second electrode layer if such is the case under any of the foregoing metrics. As depicted by way of example in FIG. 3C, any one or more of the electrode edge 309 morphology, the spacing 311 between adjacent electrodes, the positioning of the electrodes relative one to another, and/or the spacing 321 between electrodes across a central aperture may be adjusted to produce a wide range of electrode layer sizes and geometries, having a range of inter-electrode space, central aperture 315, and/or lateral gap 317 dimensions and/or cross-sections. In embodiments, electrode layers may have any dimensions and/or geometry found useful for producing desired central passage and/or lateral passage size and morphology and/or desired electromagnetic field characteristics. In embodiments, the perimeter footprint 323 of an electrode layer could be square, such as depicted in FIGS. 3A and 3B, rectangular, circular, or any other shape or form consistent with desired electromagnetic properties and physical constraints. In some embodiments, an electrode layer may have perimeter footprint size or largest lateral dimension 325 of about 1-2 mm, or about 2-5 mm, or about 5-10 mm, or about 1-2 cm, or about 2-3 cm, or about 3-4 cm, or about 4-5 cm, or about 5-7 cm, or about 7-9 cm, or about 9-12 cm. In some embodiments, the electrode layers of an electrode array may have generally identical perimeter footprints, which may be arranged in alignment one with another, facilitating assembly into a compact stack arrangement and/or providing a convenient geometry for electrical connections. In some embodiments, electrode layers may have perimeter footprints that are generally symmetric in shape about the center of the central aperture. In embodiments the minimum distance 321 between opposing electrodes across a central aperture could be at least about 1% of the electrode layer perimeter footprint size where a very small central aperture is desired (such as, for example, for a far downstream electrode layer) to about 75% of the electrode layer width for an electrode layer where a large central aperture is desired (such as, for example, for an upstream-most electrode layer). In embodiments the distance 311 between adjacent electrodes across a lateral gap, such as at a lateral distance at which an inlet would be positioned, could be at least about 0.5% of the electrode layer width where a very small central aperture is desired (such as, for example, for a downstream electrode layer) to about 75% for an electrode layer where a large central aperture is desired (such as, for example, for an upstream electrode layer). Thus electrode layer dimensions for an example embodiment of an electrode layer having four electrodes of hyperbolic edge geometry such as generally depicted in FIG. 3C a could include: electrode width and height of about 4.5 cm; distance across central aperture between opposing electrodes of about 0.6 cm and distance across lateral gap between adjacent electrodes of about 0.1 cm for a smallest aperture electrode layer; and distance across central aperture between opposing electrode lobes of about 2 cm and distance across lateral gap between adjacent electrodes of about 0.6 cm for a largest aperture electrode layer.

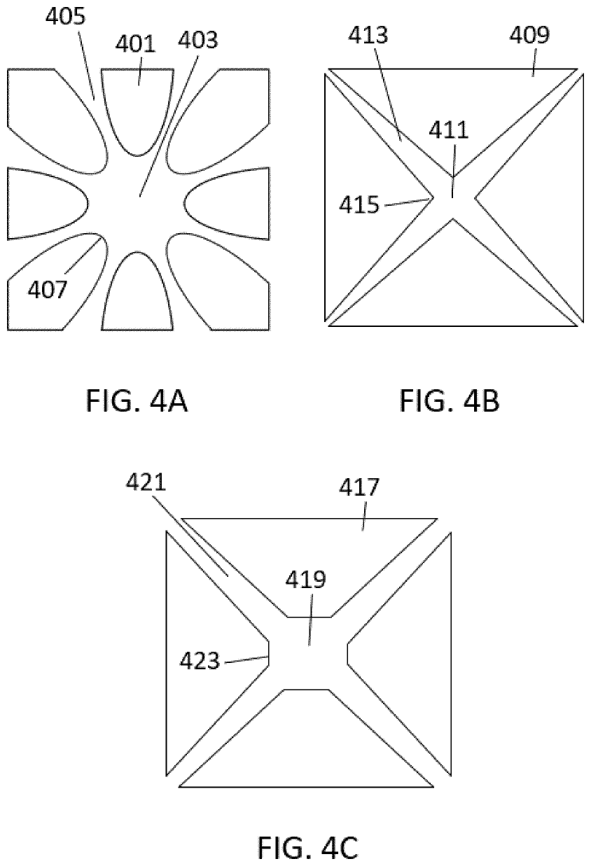

In some embodiments such as depicted, for example, in FIGS. 2 and 3A, an electrode layer may include an even number of electrodes, which may be disposed symmetrically around a central aperture. Any number of electrodes could be employed; in embodiments, it may be found advantageous to employ electrode layers having an even number of electrodes, such as four electrodes as depicted, for example, in FIGS. 2 and 3A, or eight electrodes as depicted, for example, in FIG. 4A, or any even number of electrodes from about 4 electrodes to about 42 electrodes. In embodiments, it may be found that increasing the number of electrodes may confer more fine-grained control of the electromagnetic field produced. In embodiments, electrodes may be disposed symmetrically around a central aperture, or in any other geometry, pattern, and/or relationship found useful for achieving any desired design goals, such as, for example, electrode array and/or electromagnetic field characteristics, accommodating constraints arising from fabrication considerations, and/or dimensional and geometric compatibility with other components.

In various embodiments, the morphology of the inter-electrode space may be defined in whole or part by the dimensions and geometry of the edges of the surrounding electrodes. In some embodiments such as depicted in FIGS. 3A and 3B, wherein an electrode layer may be approximately planar and thin in cross-section, the inter-electrode space-facing edge geometry of the electrodes may be generally defined by a curve in the two-dimensional plane of the electrode layer. In some embodiments, electrodes and/or electrode layers could be employed that are not planar and/or whose geometry varies in three dimensions; in such cases it may nevertheless be found useful to characterize the inter-electrode space-facing edge geometry of the electrodes in terms of a two-dimensional shape or curve, such as, for example, a projection of the actual shape onto a plane generally representative of the spatial extent of the electrode or electrode layer. Thus in some embodiments such as illustrated in FIGS. 3A and 3C, for example, the two-dimensional shape of the electrode edges 307, 309 could be generally hyperbolic. In other embodiments such as illustrated in FIGS. 4A, 4B, and 4C, the two-dimensional edge geometry of an electrode 401 could be parabolic, circular, oval, or elliptical 407 such as depicted generally in FIG. 4A, leading to corresponding differences in central aperture 403, lateral gap 405, and/or inter-electrode space morphology; the edges 415 of one or more electrodes 409 could have a triangular form such as depicted in FIG. 4B and corresponding central aperture 411 and lateral gap 413 morphology; or the edges 423 of one or more electrodes 417 could be rectangular or polygonal 423 in whole or part such as depicted in FIG. 4C, again defining a unique central aperture 419 and/or lateral gap 421 geometry; or electrodes and/or electrode layers could be provided in any other shape or form found useful for achieving desired characteristics, performance, and/or compatibility with other components. In some embodiments, the two-dimensional edge shape of an electrode could be determined according to a function in cartesian or polar coordinates, such as, for example, (x−y)ⁿ=C, where C is a constant and n is a positive integer greater than 1.

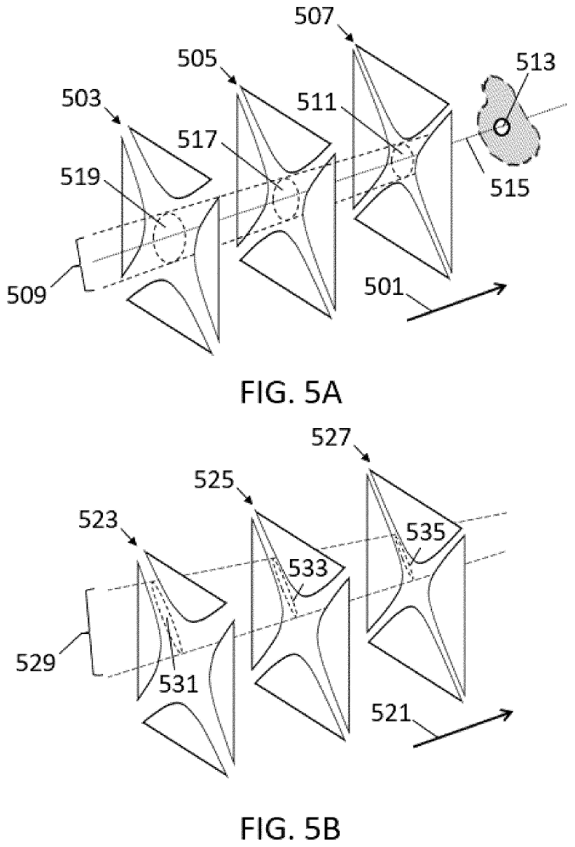

In embodiments, electrode layers having central apertures and/or lateral gaps of optionally varying dimensions and geometry can be disposed in a stack or other arrangement to provide one or more passages having desired three-dimensional morphology and extent so as to define a desired ion path, achieve desired electromagnetic field properties, and/or to achieve desired focusing or other manipulation. Thus in some embodiments as depicted schematically in FIG. 5A, a plurality of adjacent electrode layers 503, 505, 507 could be aligned and oriented so as to define an unobstructed central passage 509 passing through the central apertures 511, 517, 519 of the electrode layers and extending to the downstream 501 end of the electrode array. In embodiments, the central passage could enclose a portion of and/or be aligned with a longitudinal axis 515 projecting outward from and aligned with an outlet 513 or other locus to which ions are desired to be directed, providing an ion path for ions passing through the electrode array. In embodiments, the central apertures 519, 517, 511 of successive electrodes could vary in size and/or shape to produce a central passage or portion thereof having a desired three-dimensional morphology; for example, the central aperture of an upstream electrode layer 503 could be larger than that of one or more electrode layers 511, 517 that are downstream therefrom, resulting in a central passage having a tapered morphology. Similarly, in some embodiments such as depicted schematically in FIG. 5B, a plurality of successive electrode layers 523, 525, 527 in all or any portion of an electrode array could be aligned and oriented so as to define an unobstructed lateral passage 529 passing through the lateral gaps 531, 533, 535 of the electrode layers; again, the dimensions of the lateral gaps of the electrode layers may be selected to produce any desired lateral passage morphology, such as, for example, a gradual reduction in cross-section in the downstream direction 521. In embodiments, a lateral passage may advantageously be sized and/or oriented taking into account any relevant factors, such as, for example, the size, mass, charge, heterogeneity, and other characteristics of the analytes desired to be made to pass through the lateral passage and the characteristics of the potentials to be applied.

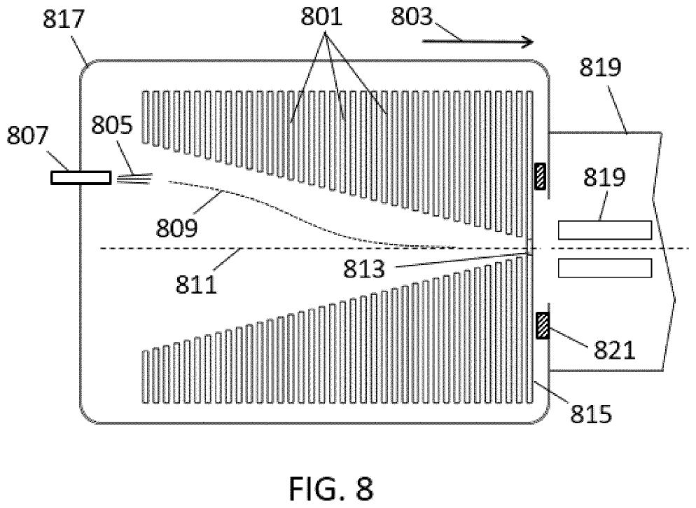

In embodiments, by appropriate selection and sizing of electrodes and electrode layers, an electrode array may be provided with one or more central passages and/or lateral passages, one or more of which may span the entire longitudinal extent of an electrode array or any segment thereof. In some embodiments, central passages and/or lateral passages could be provided extending through a plurality of but not all electrode layers in any pattern or arrangement found useful for an application of interest. In some embodiments, a central passage may preferably extend to and include the downstream-most electrode layer(s) so as to provide unobstructed communication with an outlet. In some embodiments there may be provided an outlet layer, which may be disposed at or near the downstream end of an electrode array and may have disposed therein an outlet aperture aligned with a central passage of the electrode array, as depicted, for example, in FIG. 8. In some embodiments, it may be found desirable for a lateral passage to have an upstream extent adequate to provide an unobstructed path from an off-axis inlet into the lateral passage, and a downstream portion overlapping and/or communicating contiguously with a central passage, so as to allow an unobstructed path for ions introduced by the off-axis inlet to be diverted into a portion of the central passage and aligned to impinge upon an outlet.

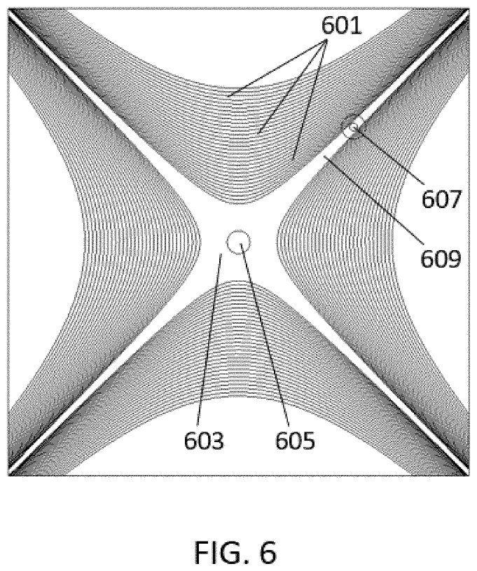

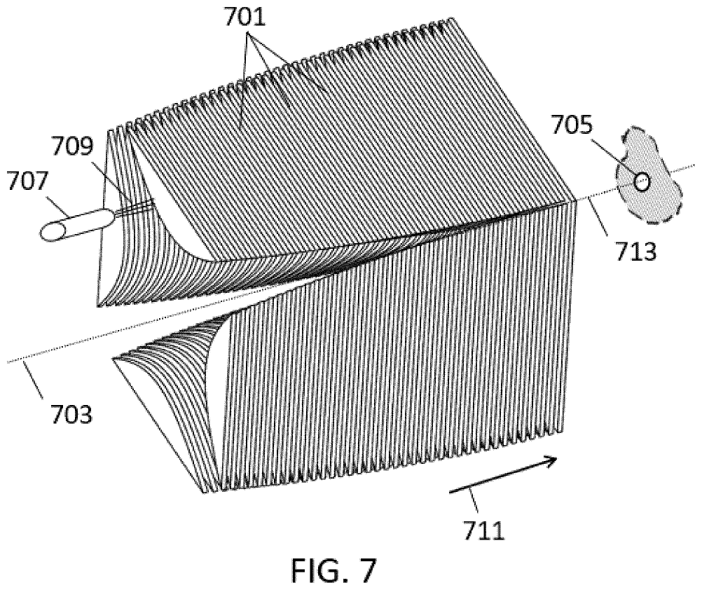

In some embodiments, an electrode array may incorporate a stacked arrangement of electrode layers whose central apertures and/or lateral gaps are monotonically diminishing in size in a downstream direction, giving a continuously tapered morphology as depicted, for example, in FIGS. 6, 7, and 8. Thus FIG. 6 depicts a view of an array having a plurality of electrode layers 601 each including four electrodes of hyperbolic edge geometry, as seen from the upstream end of the array, forming a continuous central passage 603 aligned with an outlet 605 disposed at the downstream end and an off-axis inlet 607 disposed within or in alignment with a lateral passage 609 at or near the upstream end and oriented to emit analyte into the lateral passage in the downstream direction. FIG. 7 depicts in perspective view an embodiment of an array of a plurality of electrode layers 701 each having a generally similar morphology, which could be disposed with a central passage enclosing an axis 703 aligned with an outlet 705 and wherein one or more inlets could be provided, which could include an off-axis inlet 707 positioned and oriented to dispense analyte 709 in the downstream direction 711 toward and/or into a lateral passage from which ions of interest could be acted upon by an electromagnetic field of the array and made to converge onto a trajectory 713 leading to the outlet.

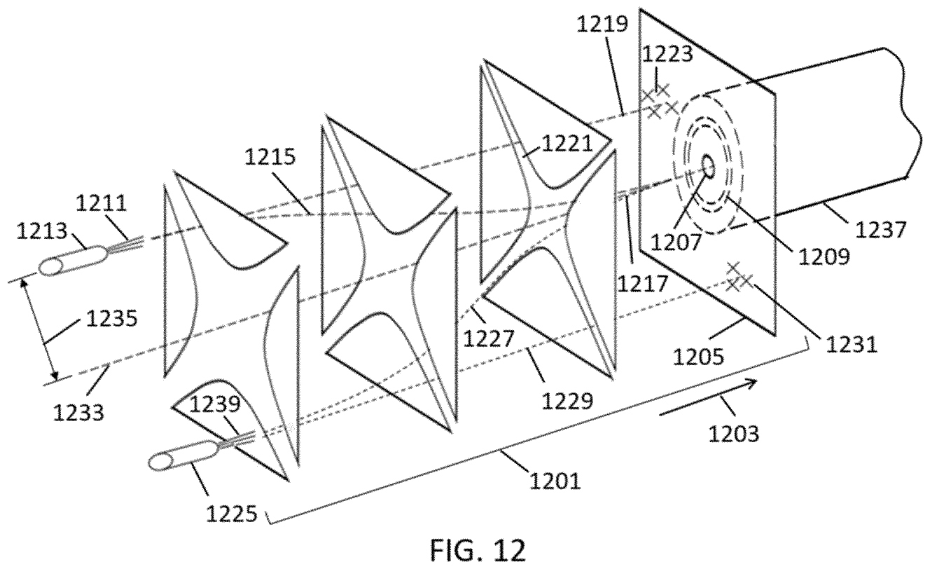

FIG. 8 depicts another example embodiment schematically in longitudinal cross-section, again having electrode layers 801 having inter-electrode spaces that monotonically diminish in size in the downstream direction 803. Ions and other charged species in an analyte stream 805 emitted from an inlet 807 may be acted upon by an electromagnetic field produced by the electrode array and guided on a trajectory 809 that could be made to merge with a path 811 aligned with an outlet which could include an aperture 813 provided in a downstream-most electrode layer. Thus in some embodiments as or in lieu of an electrode layer there may be provided an outlet layer 815, which may be disposed at or near the downstream end of an electrode array and which may, in embodiments, have a continuous surface surrounding an aperture 813 aligned with a central passage of the electrode array, so that, as described in more detail in connection with FIG. 12, ions from the analyte stream may be diverted to pass through the aperture of the outlet layer while neutral particles and other contaminants may continue on a straight line path through the lateral gaps of the upstream electrode layers at a sufficient lateral distance from the aperture of the outlet layer so as not to contaminate the ion stream passing through aperture of the outlet layer. In some embodiments, an outlet layer 815 could be incorporated with and/or form a portion of an evacuable enclosure 817 in which an electrode array is disposed, so that the aperture of the outlet layer could itself act as an outlet from the evacuable enclosure and the outlet layer or portion thereof could form a boundary or partition between the evacuable enclosure and a downstream compartment 819. Thus, in embodiments, an evacuable enclosure could include a shell, which may include a gas-impermeable shell, in combination with an outlet layer, with a seal or gasket provided at a junction between the shell and the outlet layer so as to provide a vacuum-tight connection. In embodiments, the downstream compartment may define a further vacuum stage, which could be maintainable at lower pressure than the evacuable enclosure 817. In embodiments, the downstream compartment could include and/or contain an ion guide 819, which could include, for example, a multipole ion guide such as a quadrupole, hexapole, octupole, or other multipole ion guide, a stacked ring ion guide, a second electrode array according to the disclosure hereof (which could include an electrode array having electrode layers of uniform inter-electrode space size), or any other device or component found useful for an application of interest. In embodiments, there may be provided a pressure seal 821 to avoid and/or minimize vacuum leakage and ensure that an outlet layer is incorporated in the evacuable enclosure in a pressure-tight manner. Although an arrangement wherein an aperture in a downstream-most electrode layer may serve as an outlet from the evacuable enclosure as depicted in FIG. 8 may be found convenient for many applications, it is possible for an outlet 705 to be provided separately from an electrode array, such as depicted schematically in FIG. 7. Where an outlet is incorporated in an outlet layer, the outlet layer could, in embodiments, include all or part of a downstream electrode layer provided with an aperture, which could have any desired electrical potential applied including grounding, or could be electrically isolated from the rest of the electrode array. In some embodiments, an outlet layer could be provided in the form of a layer or plate of insulating or non-electrode material such as PCB substrate material, which may be a gas-impermeable material, having an aperture provided therein. In some embodiments, an outlet layer may have a gas-impermeable surface extending at least over the entire portion between the outlet aperture and a pressure seal.

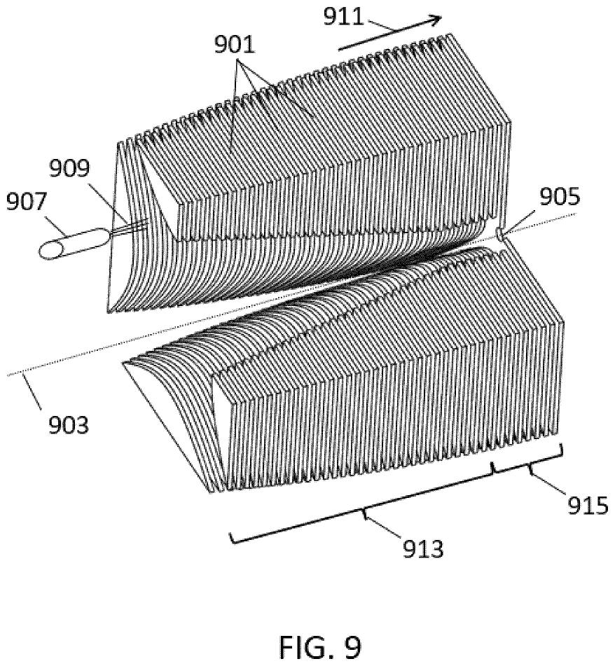

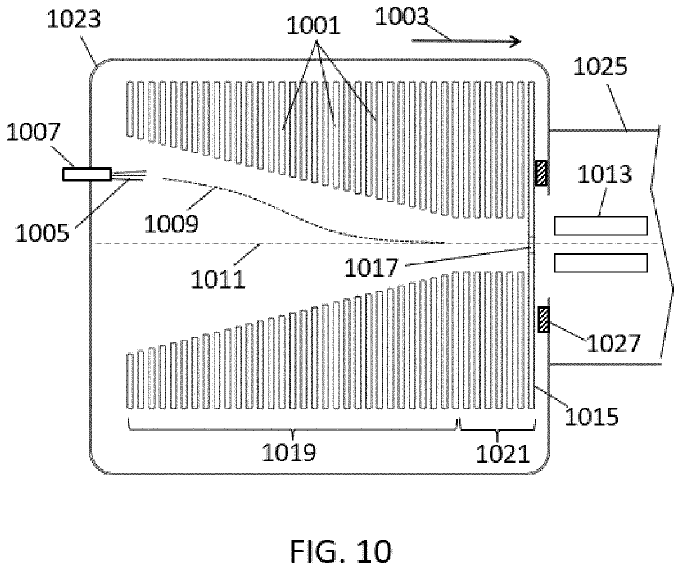

In some embodiments, an electrode array may incorporate a stacked arrangement of electrode layers whose central apertures and/or lateral gaps are monotonically diminishing in size in a downstream direction over an upstream portion of the longitudinal extent of the array, but kept approximately constant or uniform in size and/or geometry over a downstream portion, defining a central passage and lateral passages having a continuously tapered morphology in the upstream portion and transitioning to a morphology of uniform cross-section and/or constant size in the downstream portion, such as depicted, for example, in FIGS. 9 and 10. Such a morphology may be found useful, for example, to avoid reducing the inter-electrode space to a point where the electromagnetic field strength in the reduced region under operating conditions rises to a point where transmission may be cut off or reduced, and/or to avoid overly narrowing the lateral gaps and thereby minimize the deposit of neutrals and/or other contaminants on lateral gap edges of the downstream-most electrodes. FIG. 9 depicts in perspective view an embodiment of an array of 38 electrode layers 901 defining a central passage and lateral passages having a an upstream tapered portion 913 and downstream uniform 915 portion. The array may be disposed with a central passage enclosing an axis 903 aligned with an outlet 905 and wherein one or more inlets could be provided, which could include an off-axis inlet 907 positioned and oriented to dispense analyte 909 in the downstream direction 911 toward and/or into a lateral passage from which ions of interest could be acted upon by an electromagnetic field of the array and made to converge onto a trajectory leading to the outlet.

FIG. 10 depicts another example embodiment schematically in longitudinal cross-section, again having electrode layers 1001 having inter-electrode spaces that monotonically diminish in size in the downstream direction 1003 over an upstream portion 1019 and have an approximately uniform morphology over a downstream portion 1021; ions and other charged species in an analyte stream 1005 emitted from an inlet 1007 may be acted upon by an electromagnetic field produced by the electrode array and guided on a trajectory 1009 that could be made to merge with a path 1011 aligned with an outlet 1017. In some embodiments as or in lieu of the downstream-most electrode layer there again may be disposed an outlet layer 1015 having a continuous surface with no lateral gaps and only a small central aperture serving as an outlet. Thus in some embodiments an outlet layer may serve as a boundary or partition between the interior of an evacuable enclosure 1023 containing an electrode array, and a downstream chamber 1025 which could serve as a further vacuum stage and/or could include and/or contain one or more additional components or instrumentation, such as, for example, an ion guide 1013 (such as, for example, a multipole ion guide such as a quadrupole, hexapole, octupole, or other multipole ion guide, a stacked ring ion guide or any other type of ion guide found useful), a second electrode array according to the disclosure hereof (which could include an electrode array having electrode layers of uniform inter-electrode space size), or any other device or component found useful for an application of interest. In embodiments, there may be provided a pressure seal 1027 to avoid and/or minimize vacuum leakage and ensure that the downstream-most electrode layer and/or outlet layer in which an outlet aperture is provided makes a vacuum-tight seal with the shell of the evacuable enclosure so that vacuum leakage between the evacuable enclosure and the downstream chamber is substantially confined to the outlet aperture.

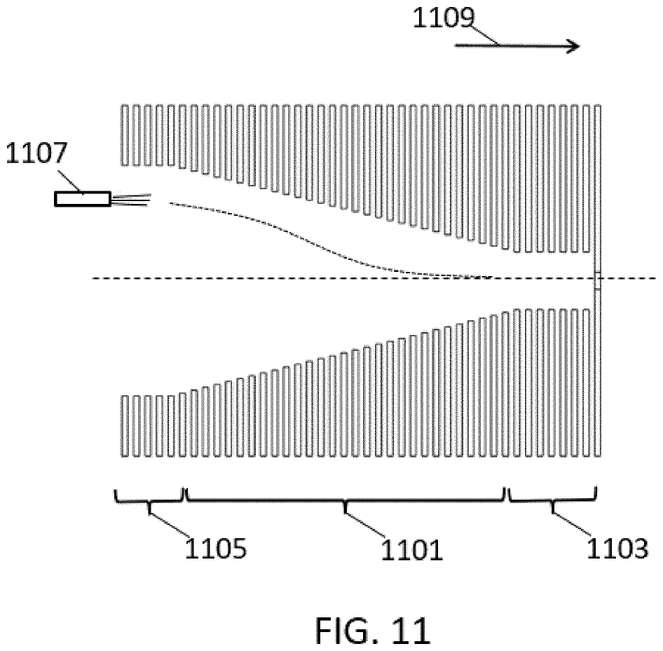

In some embodiments an electrode array may have central and/or lateral passages, as depicted schematically by way of example in longitudinal cross-section in FIG. 11, having a tapered morphology in the downstream direction 1109 in a central portion 1101, a relatively narrow approximately uniform morphology in a downstream portion 1103, and a relatively wider approximately uniform morphology in an upstream portion 1105, with an off-axis inlet 1107 provided in the upstream portion. In some embodiments, an electrode array could include electrode layers having interelectrode spaces that remain approximately uniform in size and/or geometry over all or any portion of the longitudinal extent of the electrode array. In some embodiments, the sizes of the inter-electrode spaces of successive downstream electrode layers of an electrode array or any portion thereof may be monotonically decreasing, weakly monotonically decreasing, monotonically increasing, weakly monotonically increasing, or may vary according to any other scheme or pattern found useful for an application of interest. In some embodiments, there may be provided electrode layers having inter-electrode spaces of any dimensions and geometry and/or defining passages and/or ion paths of any dimensions and morphology, deemed useful for an application of interest. In some embodiments of an electrode array, it may be found preferable for the difference in inter-electrode space sizes between the electrode layer(s) having the largest inter-electrode space and those having the smallest since a larger difference, and/or the degree of taper of the central and/or lateral passages of the electrode array, to be in an intermediate range, since a large taper and/or change in inter-electrode space size over the longitudinal extent of the array may result in undesirable narrowing of the ion transmission window, while a too small taper and/or change in inter-electrode space size may reduce the effectiveness of the off-axis injection for minimizing contamination. In embodiments, it may be found preferable to choose electrode layer dimensions and geometry providing an intermediate degree of variation in inter-electrode space sizes; thus, for example, electrode layer dimensions and geometry could be chosen whereby the ratio of maximum to minimum inter-electrode space effective cross sections is at least about 3 and/or not more than about 6. Nevertheless, ratios less than 3 or more than 6 may be employed in embodiments where conditions warrant. In some embodiments, a ratio of maximum to minimum inter-electrode space effective cross section may be at least about 1.5, or at least about 2, or at least about 2.5, or at least about 3, or at least about 4. In some embodiments, a ratio of maximum to minimum inter-electrode space effective cross section may be not more than about 3, or not more than about 4, or not more than about 5, or not more than about 7, or not more than about 10.

In some embodiments such as depicted schematically in FIG. 12, an electrode array 1201 may be terminated at the downstream 1203 end by an electrode, electrode layer, outlet layer, or other end plate 1205 having an aperture 1207 but having an otherwise uniform and/or solid surface not providing lateral gaps. Such a design may be found advantageous for reducing contamination by preventing neutrals and/or other contaminants from propagating beyond the downstream end of the electrode array. Thus an analyte stream 1211 emitted from an inlet 1213 may include, for example, both charged particles desired to be focused onto an ion path leading to an outlet, and also contaminants, which could include neutrals, small or large droplets, other uncharged particles, particles having undesired electromagnetic characteristics, and/or any other particles and/or species desired to be prevented from entering or contaminating the outlet path. By incorporating a gap-free outlet layer or end plate in an electrode array according to the disclosure hereof, the desired particles may be diverted by the electromagnetic field of the electrode array onto a trajectory 1215 converging with the desired outlet path 1217 while the uncharged particles and other contaminants unaffected or minimally affected by the electromagnetic field of the electrode array would follow an inertial trajectory 1219 passing through the lateral gaps 1221 of the electrode layers and collide harmlessly into the end layer or outlet layer at a position 1223 sufficiently displaced from the aperture 1207 so as to minimize any possible contamination of the outlet stream. This lateral displacement of the neutrals and other contaminants provides the additional advantage that most or all contamination will occur on the outlet layer or end plate and/or at or near the lateral gap edges, at sufficient lateral displacement from the outlet axis so that distortion of the electromagnetic field of the electrode array and/or contamination of the outlet analyte stream may be avoided. In some embodiments, there could be employed any electrode layer and/or outlet layer configuration and geometry operable to maintain adequate separation of a neutral/contaminant stream from an ion stream so as to avoid contamination of the latter and/or of electrodes; thus, for example, a neutral/contaminant stream could be blocked, or could be removed, such as by suction, at some locus other than an outlet layer, such as, for example, a more upstream or downstream position.

In some embodiments as further illustrated in FIG. 12, an outlet layer or end plate 1205 may serve as a boundary or partition separating the vacuum region of the electrode array from a further vacuum stage or downstream chamber 1237, thus in effect serving as part of an evacuable enclosure in which an electrode array is disposed, with an aperture 1207 of the outlet layer or end plate serving as an outlet of the evacuable enclosure. In some embodiments, so that an electrode array, including the outlet layer or end plate, may be removeable as a module for maintenance or other purposes, a vacuum or pressure seal 1209, such as, for example, an O-ring, may be provided so as to avoid vacuum leakage between the evacuable enclosure containing the electrode array and the further vacuum stage or downstream chamber, and/or between the evacuable enclosure and the exterior.

In some embodiments as further illustrated in FIG. 12, an off-axis inlet 1213 may be positioned at a sufficient lateral displacement 1235 from the outlet axis 1233 to avoid contamination of the outlet analyte stream. In some embodiments under typical operating conditions such as mass analysis on an analyte stream from electrospray ionization and injected via an atmospheric pressure inlet, it will be found that the contamination zone 1223 and/or neutral/contaminant stream 1219 will have a diameter of about 3-5 mm at the downstream end of the electrode array. In some embodiments the diameter of the contamination zone may vary depending on the length of the flight path 1219, the characteristics of the inlet, and other factors and could be smaller than 3 mm or larger than 5 mm. In some embodiments, any neutral/contaminant impact zone that is away from the center by an aspect ratio of about 3 will be mostly shielded from impacting the center. Thus in some embodiments it may be found advantageous to position an off-axis inlet at sufficient displacement from the outlet axis whereby the contamination zone is displaced from the outlet 1207 by at least about 5 times the diameter of the outlet aperture, or at least about 7 times, or at least about 10 times, or at least about 15 times. In some embodiments, the displacement of an inlet from an outlet axis may be at least about 5%, or at least about 10%, or at least about 20%, or at least about 30%, or at least about 40%, of the minimum lateral dimension of the electrode array or of a distal layer or end plate thereof In determining the displacement 1235 of an inlet from an outlet axis, in embodiments, it may also be found useful to take into account the positioning of the inlet stream relative to the lateral passage between the lateral gaps of the electrodes. In some embodiments, excessive displacement could impair performance owing to undue narrowness of the lateral passage at large displacements from the central aperture and/or owing to exceeding the ability of a particular electrode configuration to efficiently deflect ions over a larger distance, while insufficient displacement could cause contamination of electrodes that are too close to the outlet aperture and causing distorted electromagnetic field, and in the end decrease ion transmission due to insufficient separation of ions from neutrals and contaminants. Further, in some embodiments it may be found preferable to adjust the lateral gap width of one or more electrode layers at the downstream end of an electrode array, so as to reduce accretion of contaminants on or around the lateral gap-facing electrode edges.

In some embodiments, a buildup of contaminants on device components, such as, for example, electrodes, electrode edges, electrode layers, outlet layer, and/or end plates may be detected, such as from alterations in the electromagnetic field, from effects on applied potentials or currents, by employing one or more sensors, or in any other manner operable to produce a response from which a contamination state may be inferred. In some embodiments functionality may be provided to remove contamination when detected above a threshold. In some embodiments, for example, accumulation of contaminants on a downstream end plate or electrode layer may cause a detectable electrical impedance change; the contamination level may be inferred by monitoring the electrical impedance, and if found to exceed a threshold a maintenance event may be triggered automatically by software or in any other operable manner.

A further advantage of some embodiments of the innovative electrode array design disclosed herein is that, as illustrated schematically in FIG. 12, a second analyte stream 1239, which may be obtained from a second off-axis inlet 1225, may be provided. As with the first inlet 1213, the second inlet may be displaced laterally from a central axis of the electrode array 1233 and positioned and oriented to emit an analyte stream passing through the lateral gaps of at least some electrode layers. Again the ions or other particles of interest may be diverted to follow a trajectory 1227 eventually converging on a path aligned with the outlet 1207, while the neutral particles and/or other contaminants may continue on a straight line path 1229 to collide with the outlet layer at a position 1231 laterally displaced from the outlet aperture. In a similar manner additional inlet streams could be simultaneously accommodated provided that the requisite number and/or size of lateral passages are provided for. Thus in embodiments an ion collector or other device incorporating an electrode array according to the disclosure hereof may have two or more input channels, such as, for example, by connecting a device to a multi-nozzle spray emitter, whereby keeping the spray channels separated even after entering the vacuum provides increased transmission compared to a solution in which multiple inlet streams are combined. In some embodiments, multiple inlets may be used to facilitate calibration; a calibrant may be introduced via one of the inlets, independently of the analyte, reducing cross-contamination between analyte and calibrant and allowing for fast switching of detection between the analytical and calibration channels. Such switching may be especially advantageous for high accuracy/high resolution mass analysis instruments, which benefit from more frequent calibration.

In some embodiments, an electrode array may include electrode layers that may be disposed in any spacing one from another; any number; any orientation; any distribution and/or ordering of central aperture and/or lateral gap dimension, geometry, and/or positioning; any distribution and/or ordering of material and/or electromagnetic properties; and/or any spatial arrangement, whereby upon activation of some or all electrodes and/or electrode layers by suitable potentials there is produced an electromagnetic field having desired properties. In embodiments, the number and spacing of electrodes and/or electrode layers in an electrode array may be found to affect the resolution at which the electromagnetic field produced by the array can be controlled; in general, and the effects of other factors being held constant, decreasing the spacing between adjacent electrode layers and/or increasing the number of electrode layers may be found to facilitate more fine-grained control of the electromagnetic field produced by the array. In some embodiments, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 or more electrode layers may be assembled into an electrode array. In some embodiments any number of electrode layers from about 4 layers to about 500 layers may be employed.

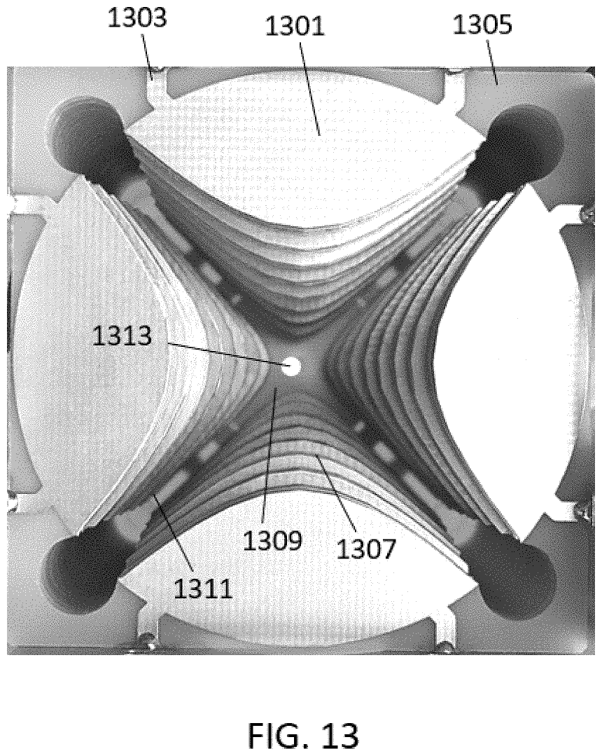

In some embodiments, adjacent electrode layers may be separated in whole or part by gaps, or by insulating spacers, and/or there may be interposed any other components found useful for an application of interest. In some embodiments, some or all electrodes and/or electrode layers may be provided with connectors for applying a desired electrical potential, which may include any of the many connectors and/or connector types familiar to persons of skill in the art, and/or any other devices and/or components operable to establish an electrical connection between a potential source and an electrode and/or electrode layer. In embodiments, electrodes and/or electrode layers may be composed of and/or fabricated from any materials and in any manner operable to achieve desired operating characteristics. In embodiments, electrodes should typically be fashioned in whole or part from one or more conductive materials. In some embodiments, it may be found convenient to fabricate electrode layers by etching the desired electrode shapes onto printed circuit boards (PCBs). These can then be stacked to form an electrode array, with the circuit board material serving as insulating spacers to maintain a desired spacing between adjacent electrode layers, and providing a convenient substrate for mounting and/or providing electrical connections to other components such as biasing resistors, coupling capacitors, and/or potential sources, directly and/or via side connections to other PCB's and/or in any other manner operable to provide desired connections. FIG. 13 depicts an example embodiment of an electrode array fabricated in this manner, viewed from the upstream end, in which the electrodes 1301, electrical connections thereto 1303, and PCB substrate 1305 of the upstream-most layer are visible in the foreground and the hyperbolically shaped edges 1307 of the further downstream electrodes and the aperture 1313 in the downstream end layer are visible through the central passage 1309 and lateral passages 1311; the central passage and lateral passages have been formed by cutting away the PCB material from the corresponding areas of the layered PCB's. In embodiments employing an economical PCB design, electrodes may be plated cut-out on PCB, and multiple PCBs can be stacked together to form an electrode array and/or soldered or otherwise connected to side PCBs with biasing resistors and coupling capacitors populated. In some embodiments, some or all electrodes may be fashioned using any operable fabrication technique(s), singly or in combination; examples could include traditional machining, 3D printing or other additive manufacturing methods, casting, forging, plating, etching, and lithography.

In many embodiments, the use of an electrode array to focus, guide, and/or otherwise manipulate ions and/or other charged species will be best carried out under conditions of vacuum so as to avoid collisions with air or gas molecules that may deflect or otherwise interact with the ions of interest and/or alter their charge. Thus in some embodiments an electrode array may preferably be disposed within an evacuable enclosure or chamber in which a suitable vacuum may be maintained during operation. Choice of the degree of vacuum for best operation may depend on the analyte, analyte source, and/or intended function of an instrument in which an electrode array is incorporated, and may entail tradeoffs between electrode array performance and material transport considerations arising from the need to maintain passages communicating with inlets or outlets that operate at pressures different from that within the enclosure. For example, in embodiments wherein analytes are introduced via an atmospheric pressure inlet, the degree of vacuum obtainable may be limited due to the transport of material through the inlet. In some embodiments, an electrode array should ideally be operated within an electrode enclosure capable of being evacuated and maintained at a pressure of less than about 1 mTorr, or less than about 10 mTorr, or less than about 100 mTorr, or less than about 1 Torr, or less than about 2 Torr, or less than about 4 Torr, or less than about 8 Torr, or less than about 15 Ton, or less than about 25 Torr during operation and taking into account vacuum loss due to the inlet. However, an advantage of the innovative electrode array design disclosed herein is that because of the improved focusing and reduced contamination of the output stream, the electrode array may be functional and effective at much higher pressures up to about 5 Torr, or up to about 10 Torr, or up to about 20 Torr, or up to about 30 Torr, or up to about 50 Torr. In embodiments, the outlet of the electrode enclosure may be coupled to and routed through one or more additional vacuum stages wherein the pressure may be reduced in steps to any pressure needed for compatibility with a mass spectrometric or other instrument.

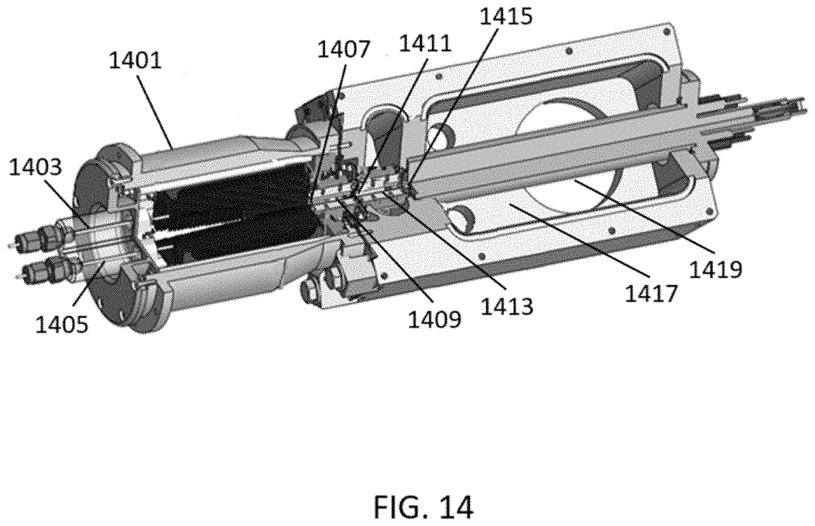

In some embodiments, such as the example embodiment depicted in FIG. 14, an electrode array may be incorporated into a device or module for interfacing between an analyte source such as, for example, an output stream from a chromatography instrument, and an analytical instrument such as, for example, a mass spectrometry instrument. Thus in some embodiments there may be provided an instrument and/or system including one or more of: an analyte source; an ionization device such as, for example, an electrospray ionization device; an evacuable chamber in which there is disposed an electrode array according to the disclosure hereof; electrical components for applying desired potentials to the electrodes of the electrode array; one or more additional vacuum stages, which could include ion guides; a further stage including an analytical instrument or component such as, for example, a mass analyzer and/or mass spectrometer device; and/or interfacing to provide control of and reporting of output from the system and/or any component thereof. In an exemplary embodiment of a system, an analyte source may provide one, two, or more analyte streams, which could be in the form of a liquid or solution, at or near atmospheric pressure, introduced via one, two, or more atmospheric pressure inlets 1403, 1405, which may emit analyte including ions into a first evacuable chamber 1401 enclosing an electrode array. This chamber may be maintained as a first vacuum zone at a first pressure, which could be determined as described above, via a suitable vacuum pump or other vacuum source. The ion stream from the electrode array may be made to pass outward from the first chamber through a first aperture 1407 into a second vacuum zone/ion guide 1409 which could be maintained at a reduced pressure relative to the first vacuum zone. From thence, the ion stream may be made to pass through a second aperture 1411 into a third vacuum zone/ion guide 1413, which could be maintained at a further reduced pressure relative to the second vacuum zone. From the third vacuum zone the ion stream may be made to pass through a third aperture 1415 into a fourth vacuum zone 1417, which could, for example, contain a mass analyzer 1419 or any other instrument or device found useful for an application of interest, such as, for example, a quadrupole mass analyzer, a triple quadrupole mass spectrometer, a time-of-flight mass spectrometer, or an ion trap device. In other embodiments, more or fewer vacuum zones could be employed and in this manner the vacuum level may be sequentially stepped down to any pressure needed for an instrument or application.

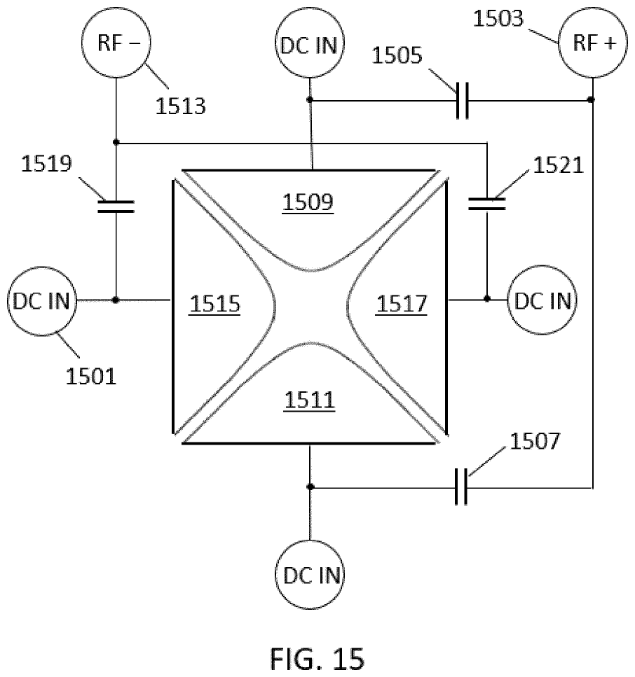

In embodiments, an electrode array may be made to produce a desired electromagnetic field, which may be a time-varying field, such as could be used to focus and/or manipulate ions and/or other charged species and/or to propel them along a desired trajectory. To do so electrical potentials may be applied to any one or more electrodes and/or electrode layers in any sequence and/or having any values, levels, frequencies, phases, and/or other characteristics found useful for producing a desired effect. FIG. 15 illustrates schematically a simple embodiment of an electrical layout that could be used to apply potentials to a single electrode layer having four electrodes. In this example embodiment the same direct current (DC) bias 1501 is applied to all four electrodes of the electrode layer; as will be seen, in some embodiments this DC bias could typically be made to vary from layer to layer over the longitudinal extent of the electrode array, with each electrode layer receiving a different DC bias that could, for example, increase or diminish monotonically or in any other desired pattern over the longitudinal extent of the electrode array so as to produce a longitudinal DC gradient in the electric field of the array so as to propel charged species in the longitudinal direction. In the example embodiment depicted in FIG. 15, an alternating potential 1503 (“RF+”) may be applied through coupling capacitors 1505, 1507 to two electrodes 1509, 1511 positioned opposite each other across the central aperture, and a potential 1513 (RF−) having the same amplitude and frequency as the RF+ potential is applied 180 degrees out of phase therefrom to another opposing pair of electrodes 1515, 1517, again via coupling capacitors 1519, 1521. Again, in some embodiments this alternating potential could be made to vary from layer to layer over the longitudinal extent of the electrode array, with each electrode layer receiving an alternating potential that could differ in amplitude, frequency, phase, waveshape, time dependence, or any other characteristics from the alternating potentials applied to other electrodes and/or electrode layers, in any pattern found useful for producing an electromagnetic field having desired characteristics.

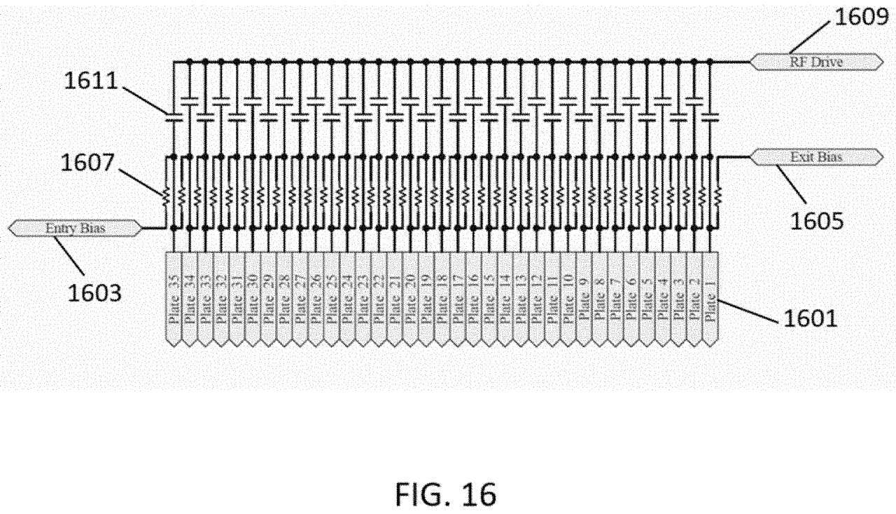

FIG. 16 depicts schematically a simple example embodiment of an electrical layout and connections that could be used to apply, over a plurality of electrode layers, electrical potentials that may be made to vary from one electrode layer to another over the longitudinal extent of an electrode array. In this example embodiment each electrode layer may include four electrodes disposed around a central aperture generally as depicted in FIG. 15, but electrode layers may vary in central aperture and lateral gap sizes such as depicted, for example, in FIGS. 6 through 11. The schematic shown in FIG. 16 illustrates exemplary electrical connections to one electrode in each electrode layer; the connections to the other three electrodes in each electrode layer could be similar, with each pair of opposing electrodes receiving the same DC and RF potentials, and with one pair receiving an RF potential 180 degrees out of phase relative to the other pair. Thus as shown in FIG. 16 there may be applied to an electrode of each successive plate or electrode layer 1601 a DC bias potential by applying a potential difference between an entry bias 1603 and an exit bias 1605 across a voltage divider 1607 so as to produce a DC potential that decreases monotonically over the stack of electrode layers. In some embodiments, by way of examples and depending upon the application and conditions, the DC potentials applied to the upstream-most and downstream-most electrode layers, relative to the potential of the outlet aperture of the enclosing chamber or other suitable ground reference, could be 10 V and 1 V, respectively, or 25 V and 2V, respectively, or 450 V and 15 V, respectively, or any other values found useful to produce desired electromagnetic field characteristics.

Further, there may be applied to each of the electrodes an RF potential 1609 of the desired phase via coupling capacitors 1611. In some embodiments, the applied RF amplitude could be uniform over all of the electrode layers. In some embodiments it may be found useful to increase the RF amplitude as the size of the electrode increases, which may provide benefit to enlarge the transmission window or range of mass to charge rations that can be transmitted through the device. In some embodiments, the potential applied to electrodes under operating conditions may typically be in the range of about 100V to 200V peak to peak, or in some applications could be as low as about 50V or as high as about 400V. Excessively high potentials may be found to cause arcing, while unduly low potentials may fail to achieve adequate ion focus. In some embodiments, the applied RF frequency may be any frequency found operative to produce desired performance. In typical embodiments for mass analysis an RF potential may be applied at a frequency of about 1 MHz, or in a range from about 100 kHz to about 5 MHz, with the lower end of the range preferred for some applications such as, for example, analytes including large biomolecules, and frequencies higher than about 5 MHz becoming challenging in terms of electronics implementation; nevertheless, frequencies below 100 kHz or above 5 MHz may be employed when it is found advantageous to do so. Determination of optimal amplitudes and frequencies may typically entail consideration of factors such as, for example, the dimensions of the electrode array, the mass, charge, and other characteristics of the intended analytes, and the pressure, and may be adjusted to achieve desired performance.

In some embodiments, ions may be introduced from the an atmospheric pressure inlet, capillary or orifice, and enter the field created by the direct current and/or radio frequency potentials applied to the electrodes. The electrode array may act as an ion collector and focus the ions through the openings between the electrodes and propel them through the electrode array. As discussed above, the inlet capillary or orifice may be positioned off-axis with respect to the outlet aperture (relative to the longitudinal axis that defines the translation direction through the instrument). The off-axis position of the inlet provides advantage in reducing the potential line of sight translation of the neutral species or charged microdroplets from the electrospray. Because of the off-axis position, species must be focused and actively transported by the ion collector/electrode array to pass through the on-axis outlet aperture. Any neutral beam will not be transported because it will not be affected by the ion collector field and so will be pumped away or strike the end layer plate, unlike the ion beam, which will be bent towards the center and transmitted through the exit aperture. In some embodiments, in order to provide focusing and transport of ions, the stacked electrode array/ion collector may have RF (radiofrequency) and DC (direct current) potential applied to the electrodes. The electrodes may be DC-biased with resistors to create DC potential that decreases in a downstream direction, moving ions from upstream to downstream. RF potentials may be coupled by capacitors to each individual electrode. In an embodiment having monotonically diminishing inter-electrode space sizes in successive downstream electrode layers, application of a uniform RF potential could result in increase of the RF field intensity in the downstream electrode layers and thus cause a cut off for ions of low m/z values, limiting transmission. In some embodiments, this effect can be mitigated by maintaining a uniform inter-electrode space size over a plurality of the downstream-most electrode layers, as illustrated for example in FIGS. 9, 10, and 11. In some embodiments, low mass cut off limitation may be avoided or mitigated by utilizing an RF driver providing additional outputs so that predetermined potentials may be applied to specific electrodes or groups of electrodes or electrode layers. Conventional RF drivers for ion funnels or ion guides, as commonly used, for example, in current mass spectrometers, typically provide two outputs at the same amplitude, with 180 degrees phase offset; these phase-opposite RF outputs are then applied to the neighboring plates of the ion funnels (or neighboring rods of a multipole ion guide) so that adjacent plates always have opposite RF phase. Finer grained control may be obtained by employing an RF driver providing a plurality of outputs whereby different amplitude and/or phase RF waveforms may be applied to different electrodes. For example, in embodiments, the upstream electrode layers could be driven by relatively higher amplitude RF potentials while the downstream layes could be driven by relatively lower amplitude RF potentials, thereby reducing the field intensity within the smaller downstream electrode layer openings. In some embodiments, this can be accomplished via a coil provided with multiple taps so that electrodes can be connected to specific location on the coil corresponding to desired amplitudes. In some embodiments, an RF driver could be employed providing potentials of any amplitude, frequency, phase and/or other characteristics to each individual electrode, or to predetermined groups of electrodes. In some embodiments, an intelligent RF driver could include logic circuitry and/or be programmed to apply and optionally adjust and/or vary the potentials applied to electrodes and/or groups thereof in response to user control, sensor feedback, or any other inputs found usefully informative. In some embodiments, it may be found useful to optimize the amplitude, frequency, phase and/or other characteristics of applied potentials, and the distribution of applied potentials over the electrodes, according to the mass, charge, and other characteristics of the analytes to be handled.

For convenience of description, electrode arrays may be characterized herein in terms of generally planar electrodes organized in generally planar electrode layers that are in turn arranged as a stack of electrode layers, and, indeed, such arrangements may be found to offer significant advantages in terms of simplicity, ease of fabrication, and other practical considerations. However, many variations are possible using electrodes that are not necessarily planar, and/or not necessarily organized in planar layers and/or stacked arrangements thereof, but may be equivalently operative in terms of the electromagnetic field producible and/or functionality for propelling ions or other analytes on a trajectory from an off-axis ion or analyte source, extending through lateral gaps between electrodes, and approaching and/or merging with a longitudinal axis aligned with an outlet or other target locus. The disclosure hereof is intended to extend to all such alternative arrangements. Thus, in some embodiments, an electrode array could include any arrangement of a plurality of electrodes operable to modify and/or act upon the trajectory of an ion or analyte stream wherein the electrodes demarcate an unobstructed passage from an off-axis position at or near the upstream end of the electrode array, passing in a generally longitudinal direction through one or more lateral gaps between electrodes, and communicating contiguously with an unobstructed passage enclosing at least a downstream portion of a longitudinal axis aligned with the intended ion output direction. An electrode array may include any number of electrodes, disposed at any spacing and any orientation, found useful to produce a desired electromagnetic field.

### EXAMPLE 1

An ion collector including an electrode array according to the disclosure hereof was made from material, with geometry, dimensions and tuning electrical parameters as follows: Stainless steel was used to make hyperbolic electrodes in sets of 4, assembled in electrode layers generally as depicted in FIG. 3A. 100 electrode layers were used to assemble the electrode array. The thickness of the electrodes was 0.25 mm. The pitch, i.e. the spacing between adjacent electrode layers, was 0.5 mm. The distance between the vertex of an electrode and the center of the electrode layer was 25 mm in the first electrode layer and 5 mm in the last electrode layer (wherein the center is taken as the intersection of the asymptote and the semi major axis of the hyperbola traced by the electrode edges). Onto the electrodes there was applied a sinusoidal RF waveform at a frequency of 0.5 MHz. The RF was phase modulated so that neighboring electrodes always receive a wave that is 180 degrees shifted relative one to the other. The amplitude of RF waveform was set to 1000 V peak to peak. To the first (upstream-most) electrode there was applied a DC potential of 450 V, and to the last electrode 15 V, relative to the potential of the outlet aperture. Ions are introduced from inlet transfer tubing positioned 15 mm off axis of the main translation axis of the ion collector. The operational pressure inside ion collector chamber was kept at 10 Torr.

### EXAMPLE 2

An ion collector including an electrode array according to the disclosure hereof was made from material and with geometry, dimensions and tuning electrical parameters as follows: Stainless steel was used to make circular electrodes in sets of 6. 16 sets were assembled into electrode layers which were stacked to assemble the ion collector. The thickness of the electrodes was 9 mm. The pitch between electrode layers was 10 mm. The distance between the vertex of an electrode and the center of the electrode layer was 5 mm in the first electrode layer and 1 mm in the last electrode layer. The sinusoidal RF waveform applied to the electrodes had frequency of 5 MHz; The RF was phase modulated so the neighboring electrodes always receive a wave that is 180 degrees shifted. The amplitude of the RF waveform was set to 50 V peak to peak. The first electrode was set to a DC potential of 10 V, the last to a potential of 1 V, relative to the outlet aperture. The ions are introduced from an aperture aligned with the main translation axis of the ion collector. The operational pressure inside the chamber containing the ion collector was kept at 0.05 Torr.

### EXAMPLE 3

An ion collector including an electrode array according to the disclosure hereof was made from material and with geometry, dimensions and tuning electrical parameters as follows: Edge-plated printed circuit board was used to make hyperbolic electrodes in sets of 4 generally as depicted in FIG. 13. 35 sets of electrodes were used to assemble the ion collector. The thickness of the electrodes was 0.6 mm. The pitch between the sets was 2.54 mm. The first electrode set had distance between the vertex of the electrode and the center of the set of 15 mm; for the last electrode set the distance was 6 mm (wherein the center is again taken as the intersection of the asymptote and the semi major axis of the hyperbola traced by the electrode edges). The sinusoidal RF waveform applied to the electrodes had a frequency of 2 MHz. The RF was phase modulated so the neighboring electrodes always receive a wave that is 180 degrees shifted. The amplitude of RF waveform was set to 350 V peak to peak. The first electrode was set to a DC potential of 25 V, the last 2 V, relative to the outlet aperture. Ions are introduced from an inlet capillary positioned 7 mm off axis of the main translation axis of the ion collector. The operational pressure inside the chamber with ion collector was kept at 2 Torr.

### CONCLUDING MATTER

The disclosed methods, systems, devices, apparatus, compositions, articles of manufacture, and improvements thereof have been explained above with reference to several embodiments. Other embodiments will be apparent to those skilled in the art in light of this disclosure. Certain aspects of the described subject matter may readily be implemented using configurations other than those described in the embodiments above, or in conjunction with elements other than those described above. For example, different components, electrical and/or electronic circuits, algorithms and/or logic circuits, perhaps more complex than those described herein, may be used. Although many of the examples and embodiments described herein relate to mass spectrometric instrumentation, ion guides, ion collectors, and ion focusing, the disclosed principles, methods, and components may also be readily adapted to any subject matter wherein an analyte stream is desired to be manipulated in whole or part by an electromagnetic field.

Further, it should also be appreciated that the described subject matter can be implemented in numerous ways, including as a process, an apparatus, or a system. Methods described herein may be implemented in whole or part by program instructions for instructing a processor and/or one or more actuators or devices to perform a sequence of steps, and such instructions may be recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. Any of the methods of the present disclosure may be implemented in whole or part in hardware, software, firmware, logic circuitry, analog circuitry, or any combination thereof, and may be carried out using any of the disclosed devices or apparatus according to any aspect or embodiment of the present invention, or in any other operable manner, in any operable combination. The order of the steps of the methods described herein may be altered and still be within the scope of the disclosure.

In the foregoing disclosure, specific functions may be attributed to specific components or modules. It will be apparent that the functional boundaries between components or modules are substantially artificial; functionality attributed to two or more modules or components could equivalently be combined in a single module or component, and functionality attributed to a single module or component could equivalently be distributed among two or more modules or components. In embodiments, such functions and their associated modules and/or components may be disposed in a single physical unit or housed in two or more physically separate units. Communication and interfacing among modules and/or components may be by any operable modality, such as, for example, by physical components, physical wiring, electronic circuitry, integrated circuits, and/or wireless and/or optical linkages. The disclosure hereof extends to all such equivalent arrangements.

In embodiments, fabrication of devices and/or components may be by any manner or technique operable to produce the described structure and/or known to persons of skill in the art, and is not limited to the specific examples, if any, described herein. In embodiments, components and/or substructures described herein as having fixed positions relative one to another may be held in position in any manner operable to maintain the specified positions under conditions of normal use as described herein, such as, by way of example only, by the use of mechanical fasteners such as bolts, screws, nuts, or rivets; by heat, such as, for example, welding, brazing, or soldering; by an adhesive; by incremental deposition, such as, for example, by 3D printing; and/or by forming a component integrally or as a single piece with another component. In embodiments, components and/or substructures described herein as having movable positions relative one to another may be constrained in position in any manner operable to constrain the components and/or substructures within the specified ranges of positions under conditions of normal use as described herein, such as, by way of example only, by the use of mechanical fasteners such as hinges, sliders, tracks, followers, pivots, bearings, and/or flexible components. Unless otherwise specifically stated or required by context, mounting and/or affixation may be permanent or removable or removable and replaceable, as deemed useful for an application of interest.

For clarity and to ensure completeness, certain of the aspects and/or embodiments disclosed herein may be overlapping in scope, described repetitively, or represent recitals of the same or equivalent elements or combinations expressed in alternative language. It will be apparent that the choice of particular phraseology and/or of particular aspects or elements to assert as claims involves many complex technical and legal considerations, and no inference should be drawn that alternative descriptions of a particular element or combination in this written description necessarily do or do not encompass different subject matter; except where context otherwise requires, each described aspect or element should be interpreted according to its own description.

It is intended that this specification be interpreted in accordance with the normal principles of English grammar and that words and phrases be given their ordinary English meaning as understood by persons of skill in the pertinent arts except as otherwise explicitly stated. If a word, term, or phrase is intended to be further characterized, specified, or narrowed in some way, then additional adjectives, modifiers, or descriptive text have been included in accordance with the normal principles of English grammar. It is intended that the meanings of words, terms, or phrases should not be modified or characterized in a manner differing from their ordinary English meaning as understood by persons of skill in the relevant arts except on the basis of adjectives, modifiers, or descriptive text that is explicitly present.

Except as otherwise explicitly stated, terms used in this specification, including terms used in the claims and drawings, are intended as “open” terms. That is, for example, the words “including” and “comprising” should be interpreted to mean “including but not limited to,” the word “having” should be interpreted to mean “having at least,” the word “includes” should be interpreted to mean “includes but is not limited to,” the phrases “for example” or “including by way of example” should be interpreted as signifying that the example(s) given are non-exhaustive and other examples could be given, and other similar words and phrases should be given similar non-exclusive meanings. Except as explicitly stated, ordinals used as adjectives (e.g. “first object”, “second object”, etc.) in this specification, including claims and drawing figures, are intended merely to differentiate and do not imply that any particular ordering is required. Thus, for example, unless otherwise explicitly stated, “first measurement” and “second measurement” do not imply that the first measurement necessarily takes place before the second measurement, but merely that they are distinct measurements.

In the written description and appended claims, the indefinite articles “a” and/or “an” are intended to mean “at least one” or “one or more” except where expressly stated otherwise or where the enabling disclosure requires otherwise. The word “or” as used herein is intended to mean “and/or”, except where it is expressly accompanied by the word “either”, as in “either A or B”. Applicants are aware of the provisions of 35 U.S.C. § 112(f). The use of the words “function,” “means” or “step” in the written description, drawings, or claims herein is not intended to invoke the provisions of 35 U.S.C. § 112(f) to define an invention. To the contrary, if the provisions of 35 U.S.C. § 112(f) are sought to be invoked, the claims will expressly include one of the exact phrases “means for performing the function of” or “step for performing the function of”. Moreover, even if the provisions of 35 U.S.C. § 112(f) are explicitly invoked to define a claimed invention, it is intended that the claims not be limited only to the specific structure, material or acts that are described in the preferred embodiments, but in addition, extend to any and all structures, materials or acts that perform the claimed function as described in alternative embodiments or forms of the invention, or that are well known present or later-developed equivalent structures, material or acts for performing the claimed function.

In the foregoing description, various details, specific aspects, embodiments, and examples have been described in order to illustrate and explain the subject matter, to provide a thorough understanding of the various aspects, to enable persons skilled in the pertinent arts to practice the described subject matter. These details, specific aspects, embodiments, and examples are not intended to be limiting; rather, it will be apparent to persons of skill in the relevant arts that, based upon the teachings herein, various changes, substitutions, modifications, rearrangements, may be made and various aspects, components, or steps may be omitted or added, without departing from the subject matter described herein and its broader aspects. Except as otherwise expressly stated or where aspects or features are inherently mutually exclusive, aspects and features of any embodiment described herein may be combined with aspects and features of any one or more other embodiments. Titles, headings, and subheadings herein and the abstract hereof are intended merely as a convenience for indicating the general nature of subject matter, and do not limit or otherwise affect the interpretation of the content of the disclosure. The appended claims are intended to encompass within their scope any and all changes, substitutions, modifications, rearrangements, combinations of aspects or features, additions, and omissions that are within the spirit and scope of the subject matter as described herein and/or within the knowledge of a person of skill in the art. The scope of the invention is defined by the claims, and is not limited by or to the particular embodiments or aspects chosen for detailed exposition in the foregoing description, but rather extends to all embodiments or aspects as defined by the claims, as well as any equivalents of such embodiments or aspects, whether currently known or developed in the future.

So as to reduce the complexity and length of the detailed description, and to provide background in certain areas of technology, each of the materials identified in the “REFERENCES” section below is expressly incorporated by reference. Applicants believe that the subject matter incorporated is “non-essential” in accordance with 37 CFR 1.57, because it is referred to for purposes of indicating the background of the invention or illustrating the state of the art. However, if the Examiner concludes that any of the incorporated material constitutes “essential material” within the meaning of 37 CFR 1.57(d)(1)-(3), applicants will amend the specification to expressly recite the essential material that is incorporated by reference as allowed by the applicable rules.

### REFERENCES

1. R. Bahr, D. Gerlich, and E. Teloy, Ring Electrode Ion Guide, Verh. Deutsch. Phys. Ges. (4) 343 (1969).

2. D. Gerlich, Inhomogeneous RF fields: A versatile tool for the study of processes with slow ions, Part 1: Experiment (Eds.: C. Y. Ng, M. Baer), Advances in Chemical Physics Series, Vol. LXXXII. ISBN 0-471-53258-4 CD, John Wiley & Sons, Inc. (1992).

3. Schaffer, Scott A., Tang, Keqi, Anderson, Gordon A., Prior, David C., Udseth, Harold R., Smith, Richard D., A novel ion funnel for focusing ions at elevated pressure using electrospray ionization mass spectrometry, Rapid Communications in Mass Spectrometry, 11 (16), 1813-1817 (1997).

4. Kelly R. T. et al., The Ion Funnel: Theory, Implementations, and Applications, Mass Spectrom. Rev., 29(2) 294-312, 2010.

I claim:

1. An electrode array having an upstream end and a downstream end, comprising:
a plurality of electrode layers, each electrode layer comprising a plurality of electrodes disposed around a central aperture and spaced apart one from the other to provide an open inter-electrode space comprising the central aperture and at least one lateral gap contiguous with the central aperture and extending outward therefrom between adjacent electrodes;
wherein the electrode layers are disposed in a stacked arrangement whereby the central apertures of the electrode layers are aligned to provide a central passage through the central apertures of a plurality of adjacent electrode layers and extending to the downstream end of the electrode array, and lateral gaps of the electrode layers are aligned to provide at least one lateral passage extending through the lateral gaps of a plurality of adjacent electrode layers and communicating with the central passage; and
wherein the central aperture cross-section of successive electrode layers is decreasing in the downstream direction over at least a portion of the electrode array.

2. An apparatus comprising:
an electrode array according to claim 1;
a direct current (DC) power supply controllable to apply DC potentials to electrodes of the electrode array in a gradient whereby the DC potential varies in the downstream direction; and
a radio frequency (RF) power supply controllable to apply RF potentials to a plurality of electrodes in a plurality of electrode layers of the electrode array, whereby the RF potentials of opposing electrodes are in phase and the RF potentials of adjacent electrodes are of opposite phase.

3. The electrode array of claim 1, wherein the ratio of the central aperture cross-section of the electrode layer having the largest central aperture cross-section, to the central aperture cross-section of the electrode layer having the smallest central aperture cross-section, is at least 2 and not more than 6.

4. The electrode array of claim 1, further comprising an end plate disposed at the downstream end of the electrode array, wherein the end plate comprises an aperture, and the end plate is positioned whereby the aperture of the end plate is aligned with the central passage of the electrode array and the end plate obstructs at least one lateral passage of the electrode array.

5. The electrode array of claim 1, wherein the edge geometry of the electrodes comprises an edge geometry selected from: a hyperbolic geometry, a parabolic geometry, a circular geometry, an elliptical geometry, a square geometry, a rectangular geometry, a triangular geometry, and a polygonal geometry.

6. The electrode array of claim 1, wherein each electrode layer comprises conductive laminate disposed on the non-conductive substrate of a printed circuit board (PCB), wherein the conductive laminate and non-conductive substrate material have been excised from the portions of the PCB corresponding to the central aperture and lateral gaps of the electrode layer.

7. The electrode array of claim 1, further comprising an outlet layer, the outlet layer comprising a gas-impermeable surface surrounding an outlet aperture, wherein the outlet layer is disposed at the downstream end of the electrode array with the aperture of the outlet layer aligned with the central passage of the electrode array.

8. An apparatus comprising:
an evacuable enclosure;
an electrode array according to claim 1 disposed within the evacuable enclosure;
an outlet having an outlet axis aligned within the central passage of the electrode array; and
a first analyte inlet disposed within the evacuable enclosure at a first inlet position and aligned to emit analyte into a lateral passage of the electrode array.

9. The apparatus of claim 8, wherein the first inlet position is displaced laterally from the outlet axis.

10. The apparatus of claim 8, further comprising an end plate disposed at the downstream end of the electrode array and the end plate comprising a neutral particle collision zone and an aperture;
wherein the electrode array is aligned and oriented to provide an unobstructed line-of-sight path extending from the at least one inlet through a lateral passage to the neutral particle collision zone, and the end plate is positioned whereby the aperture of the end plate is aligned with central passage of the electrode array; and wherein the centroid of the neutral particle collision zone is displaced from the center of the aperture of the end plate by a distance at least three times the width of the aperture.

11. The apparatus of claim 8, wherein the first analyte inlet comprises an inlet coupled to a sample source external to the evacuable enclosure, and an ionization component selected from an electrospray ionization device, an atmospheric chemical ionization device, and an inductive coupled plasma ionization device; and wherein the source pressure is at least about 100 Torr and less than about 1000 Torr.

12. The apparatus of claim 8, wherein the first analyte inlet comprises an atmospheric pressure ionizer operable to receive a liquid phase sample stream at a pressure of at least about 100 Torr and less than about 1000 Torr, and produce therefrom within the evacuable enclosure an analyte stream comprising ionized constituents of the sample stream.

13. The apparatus of claim 8, further comprising a second analyte inlet disposed within the evacuable enclosure at a second inlet position displaced laterally from the outlet axis and aligned to emit analyte into a lateral passage of the electrode array.

14. The apparatus of claim 8, wherein the outlet comprises a passage communicating from the evacuable enclosure to a second vacuum stage, and the pressure within the second vacuum stage is lower than the pressure within the evacuable enclosure.

15. A device, comprising an apparatus according to claim 8 and a mass analyzer coupled to receive an analyte stream therefrom.

16. An ion guide device comprising:
an evacuable enclosure;
an electrode array according to claim 1 disposed within the evacuable enclosure;
an outlet having an outlet axis aligned within the central passage of the electrode array;
a first analyte inlet disposed within the evacuable enclosure at a first inlet position displaced laterally from the outlet axis and aligned to emit analyte into a lateral passage of the electrode array;
a direct current (DC) power supply controllable to apply DC potentials to electrodes of the electrode array in a gradient whereby the DC potential varies in the downstream direction; and
a radio frequency (RF) power supply controllable to apply RF potentials to a plurality of electrodes in a plurality of electrode layers of the electrode array, whereby the RF potentials of opposing electrodes are in phase and the RF potentials of adjacent electrodes are of opposite phase.

17. The ion guide device of claim 16, wherein the peak to peak amplitude of the highest amplitude RF potential applied to an electrode is at least 50 V and not more than 1000 V, and the highest frequency RF potential applied to an electrode is at least 0.5 MHz and not more than 5 MHz.

18. A method of using an electrode array according to claim 1, comprising:
in an evacuated chamber, injecting ionized particles into a lateral passage of the electrode array;
applying DC and RF potentials to a plurality of the electrodes of the array to produce an electromagnetic field; and
controlling the electromagnetic field to divert ionized particles into the central passage of the electrode array.

19. A method of using an ion guide device according to claim 16, comprising:
introducing an analyte stream via the first analyte inlet;
by controlling the DC power supply and the RF power supply to apply potentials to electrodes of the electrode array to produce an electromagnetic field, diverting a plurality of ions from the analyte stream to a trajectory aligned with the outlet.

20. An apparatus comprising:
an evacuable enclosure;
an electrode array assembly comprising
an electrode array according to claim 1, and
an outlet layer comprising a gas-impermeable surface surrounding an outlet aperture;
wherein the outlet layer is disposed at the downstream end of the electrode array with the aperture of the outlet layer defining an outlet axis aligned with the central passage of the electrode array; and
a first analyte inlet disposed within the evacuable enclosure at a first inlet position displaced laterally from the outlet axis of the electrode array and aligned to emit analyte into a lateral passage of the electrode array;
wherein the evacuable enclosure comprises the outlet layer of the electrode array assembly, a gas-impermeable shell having a passage therein aligned to receive the outlet layer of the electrode array assembly, and a seal for establishing a gas-impermeable barrier between the outlet layer of the electrode array assembly and the passage of the gas-impermeable shell.
